(19) United States
(12) Patent Application Publication
(10) Pub. No.: US 2024/0360029 A1
(43) Pub. Date: Oct. 31, 2024

(54) CRYSTALLIZED GLASS, GLASS SUBSTRATE FOR HIGH FREQUENCY DEVICE, HIGH FREQUENCY FILTER DEVICE, LIQUID CRYSTAL ANTENNA, AMORPHOUS GLASS AND METHOD FOR PRODUCING CRYSTALLIZED GLASS

(71) Applicant: AGC Inc., Tokyo (JP)

(72) Inventors: Kazuki KANEHARA, Tokyo (JP); Kazuhiko NIWANO, Tokyo (JP); Nobutaka KIDERA, Tokyo (JP)

(73) Assignee: AGC Inc., Tokyo (JP)

(21) Appl. No.: 18/769,560

(22) Filed: Jul. 11, 2024

Related U.S. Application Data
(63) Continuation of application No. PCT/JP2023/000236, filed on Jan. 6, 2023.

(30) Foreign Application Priority Data
Jan. 14, 2022 (JP) 2022-004643

(51) Int. Cl. C03C 10/00; C03C 4/16; H01Q 1/38

(52) U.S. Cl. CPC C03C 10/0045; C03C 4/16; C03C 2214/20; H01Q 1/38

(57) ABSTRACT

The present invention relates to a crystallized glass, having a value calculated according to the following equation (A) of −50 ppm (/° C.) to 50 ppm (/° C.) when a rate of change ΔDk (/° C.) in a relative dielectric constant at 10 GHz due to a temperature is expressed by the following equation (A), and having a total content of an alkali metal oxide R₂O of 3.0% or less in terms of molar percentage based on oxides,

$$\begin{matrix}[ Math . 1 ] & \\ Δ Dk = \frac{\begin{matrix}( relative dielectric constant at 10 GHz and 60 ° C . ) - \\ ( relative dielectric constant at 10 GHz and - 20 ° C . )\end{matrix}}{\begin{matrix}( relative dielectric constant at 10 GHz and 20 ° C . ) \times \\ ( 60 ° C . - ( - 20 ° C . ) )\end{matrix}} & ( A )\end{matrix}$$

### CROSS-REFERENCE TO RELATED APPLICATIONS

This is a continuation of International Application No. PCT/JP2023/000236 filed on Jan. 6, 2023, and claims priority from Japanese Patent Application No. 2022-004643 filed on Jan. 14, 2022, the entire contents of which are incorporated herein by reference.

### TECHNICAL FIELD

The present invention relates to a crystallized glass, a glass substrate for a high frequency device, a high frequency filter device, a liquid crystal antenna, an amorphous glass, and a crystallized glass production method.

### BACKGROUND ART

In recent years, wireless transmission using a microwave band or a millimeter wave band has attracted attention as a large-capacity transmission technique. As a signal frequency increases with expansion of a frequency to be used, a dielectric substrate having excellent dielectric properties in a high frequency is required.

Examples of a material of the dielectric substrate include quartz, ceramics, and a glass. Here, among the glass, a crystallized glass in which a part of the glass is crystallized can be easily molded and inexpensively produced as compared with quartz or ceramics, and has an advantage that the dielectric properties can be further improved. Therefore, there is a need for development of a crystallized glass suitable for a glass substrate for a high frequency device.

Examples of the crystallized glass having excellent dielectric properties include a crystallized glass including an indialite or cordierite crystal, as disclosed in Patent Literature 1. However, in glass materials in the related art such as a crystallized glass, a relative dielectric constant generally exhibits a positive dependence on temperature. That is, since the relative dielectric constant increases as the temperature rises, a temperature change may influence the performance of an electronic device. Therefore, there is a need for development of a crystallized glass that can prevent a change in relative dielectric constant due to temperature in a high frequency range.

### CITATION LIST

### Patent Literature

Patent Literature 1: WO 2020/02325

### SUMMARY OF INVENTION

### Technical Problem

Therefore, an object of the present invention is to provide a crystallized glass that exhibits stable dielectric properties in a wide temperature range, with a small change in relative dielectric constant due to temperature in a high frequency range.

### Solution to Problem

A crystallized glass according to an embodiment of the present invention has a value calculated according to the following equation (A) of −50 ppm (/° C.) to 50 ppm (/° C.) when a rate of change ΔDk (/° C.) in a relative dielectric constant at 10 GHz due to a temperature is expressed by the following equation (A), and has a total content of an alkali metal oxide R₂O of 3.0% or less in terms of molar percentage based on oxides.

$$\begin{matrix}[ Math . 1 ] & \\ Δ Dk = \frac{\begin{matrix}( relative dielectric constant at 10 GHz and 60 ° C . ) - \\ ( relative dielectric constant at 10 GHz and \text{-20} ° C . )\end{matrix}}{\begin{matrix}( relative dielectric constant at 10 GHz and 20 ° C . ) \times \\ ( 60 ° C . - ( - 20 ° C . ) )\end{matrix}} & ( A )\end{matrix}$$

An amorphous glass according to an embodiment of the present invention includes, in terms of molar percentage based on oxides:
50% to 80% of SiO₂;
0.5% to 14% of Al₂O₃;
7% to 35% of B₂O₃;
3.5% to 10% of TiO₂;
0% to 10% of MgO;
0% to 8% of CaO; and
0% to 5% of BaO,
has a total content of an alkali metal oxide R₂O of 3.0% or less, and
has a total content of an alkaline earth metal oxide RO of 1% to 20%,
in which Nb, Bi, and Cu are not contained in the amorphous glass.

### Advantageous Effects of Invention

According to the present invention, it is possible to obtain a crystallized glass that exhibits stable dielectric properties in a wide temperature range, with a small change in relative dielectric constant due to temperature in a high frequency range.

### BRIEF DESCRIPTION OF DRAWINGS

FIG. 1 is a schematic top view of a filter device according to an embodiment.

FIG. 2 is a diagram showing transmission properties of a filter device prepared using a crystallized glass in Example 1.

FIG. 3 is a diagram showing transmission properties of a filter device prepared using a crystallized glass in Example 87.

FIG. 4 is an enlarged diagram of the transmission properties of the filter device prepared using the crystallized glass in Example 1.

FIG. 5 is an enlarged diagram of the transmission properties of the filter device prepared using the crystallized glass in Example 87.

FIG. 6 is a diagram showing a change in center frequency of the filter devices due to temperature prepared using the crystallized glasses in Example 1 and Example 87.

### DESCRIPTION OF EMBODIMENTS

In the present description, “to” indicating a numerical range is used in the sense of including the numerical values set forth before and after the “to” as a lower limit value and an upper limit value. Unless otherwise specified, “to” hereinafter in the present description is used in the same meaning.

In the present description, a glass composition is expressed in terms of molar percentage based on oxides otherwise specified, and mol % is simply expressed as “%”.

In the present description, the term “crystallized glass” refers to a glass in which a crystal is precipitated in a glass. In the present description, the term “crystallized glass” refers to a glass in which a diffraction peak indicating the crystal is recognized by an X-ray diffraction (XRD) method. In X-ray diffraction measurement, for example, a range of 20=10° to 90° is measured by using CuKα rays, and in the case where a diffraction peak appears, the precipitated crystal can be identified by, for example, a three strong ray method.

In the present description, the term “high frequency” refers to 10 GHz or more, preferably more than 30 GHz, and more preferably 35 GHz or more.

### Embodiment 1

A crystallized glass according to Embodiment 1 has ΔDk (hereinafter simply referred to as the ΔDk) calculated according to the following equation (A) of −50 ppm (/° C.) to 50 ppm (/° C.) when a rate of change ΔDk (/° C.) in a relative dielectric constant at 10 GHz due to a temperature is expressed by the following equation (A), and has a total content of an alkali metal oxide R₂O of 3.0% or less in terms of molar percentage based on oxides.

$$\begin{matrix}[ Math . 2 ] & \\ Δ Dk = \frac{\begin{matrix}( relative dielectric constant at 10 GHz and 60 ° C . ) - \\ ( relative dielectric constant at 10 GHz and \text{-20} ° C . )\end{matrix}}{\begin{matrix}( relative dielectric constant at 10 GHz and 20 ° C . ) \times \\ ( 60 ° C . - ( - 20 ° C . ) )\end{matrix}} & ( A )\end{matrix}$$

In the crystallized glass according to Embodiment 1, when the ΔDk is in the range of −50 ppm (/° C.) to 50 ppm (/° C.), the crystallized glass has a small change in relative dielectric constant due to temperature, and can have stable dielectric properties in a wide temperature range. The ΔDk is more preferably −45 ppm (/° C.) to 45 ppm (/° C.), still more preferably −40 ppm (/° C.) to 40 ppm (/° C.), even more preferably −35 ppm (/° C.) to 35 ppm (/° C.), particularly preferably −30 ppm (/° C.) to 30 ppm (/° C.), even still more preferably −25 ppm (/° C.) to 25 ppm (/° C.), and most preferably −20 ppm (/° C.) to 20 ppm (/° C.).

In the crystallized glass according to Embodiment 1, the alkali metal oxide R₂O is a component that contributes to improving meltability of a glass raw material, and a total content thereof is preferably 3.0% or less, more preferably 2.5% or less, still more preferably 2.0% or less, particularly preferably 1.5% or less, even more preferably 1.0% or less, and most preferably 0.5% or less, from the viewpoint of preventing deterioration of the dielectric properties of the crystallized glass.

In the crystallized glass according to Embodiment 1, a glass composition, a crystal seed, a crystallinity, and the like are not particularly limited as long as the crystallized glass that satisfies the above requirements can be obtained. For example, glass compositions of crystallized glasses according to Embodiments 2, 3, and 4, which will be described later, can be applied.

### Embodiment 2

In the following, a preferred crystal seed, crystallinity, and glass composition in the crystallized glass (hereinafter sometimes referred to as Embodiment 2) according to Embodiment 2 will be described.

### (Crystal)

The crystallized glass according to Embodiment 2 preferably includes a rutile TiO₂ crystal (hereinafter referred to as a rutile crystal). The rutile crystal is a type of TiO₂ crystal and has a tetragonal crystal structure. In addition, the rutile crystal included in the crystallized glass according to Embodiment 2 may have a hole or may have distortion. In the present description, both a crystal having a hole and a crystal having distortion are also called a rutile crystal.

The rutile crystal is a component that prevents change in relative dielectric constant due to temperature in the crystallized glass according to Embodiment 2. The mechanism by which the change in relative dielectric constant due to temperature is prevented by the rutile crystal is presumed as follows.

As described above, the relative dielectric constant of a common glass material often exhibits a positive dependence on the temperature. On the other hand, since the rutile crystal is thought to have a negative dependence of the relative dielectric constant on the temperature in the glass, it is presumed that by precipitating rutile crystal in the glass, the change in relative dielectric constant due to temperature can be prevented.

A total content of the rutile crystal is preferably 0.5 mass % or more, more preferably 1.5 mass % or more, still more preferably 2.0 mass % or more, even more preferably 2.5 mass % or more, even still more preferably 3.0 mass % or more, particularly preferably 3.5 mass % or more, and most preferably 4.0 mass % or more, with respect to the entire crystallized glass, from the viewpoint of preventing the change in relative dielectric constant due to temperature of the crystallized glass.

In addition, the total content of the rutile crystal is preferably 10 mass % or less, more preferably 9.0 mass % or less, still more preferably 8.0 mass % or less, even more preferably 7.0 mass % or less, even still more preferably 6.5 mass % or less, particularly preferably 6.0 mass % or less, and most preferably 5.5 mass % or less, with respect to the entire crystallized glass, from the viewpoint of preventing the deterioration of the dielectric properties. The total content of the rutile crystal may be 0.5 mass % to 10 mass % with respect to the entire crystallized glass.

The rutile crystal can be identified by X-ray diffraction measurement (XRD). Specifically, in the case where a peak having the largest intensity is confirmed in a range of 2θ=27.2° to 27.6° when the bulk body of the crystallized glass is crushed and is measured by XRD using CuKα rays at 2θ=10° to 90°, the crystallized glass includes a rutile crystal.

In order to obtain a more accurate crystal structure, it is preferable to perform Rietveld analysis. According to the Rietveld analysis, quantitative analysis of the crystal phase and the amorphous phase and structural analysis of the crystal phase can be performed. The Rietveld method is described in “Crystal Analysis Handbook” edited by the Crystallographic Society of Japan Editing Committee of “Crystal Analysis Handbook” (Kyoritsu Shuppan, 1999, p492 to 499). The content of the rutile crystal in the present crystallized glass can be calculated by Rietveld analysis using a measurement result obtained by the XRD.

The crystallized glass according to Embodiment 2 may include a crystal other than the rutile crystal as long as the effects of the present invention are not impaired. Examples of the crystal other than the rutile crystal include anatase, brookite, alumina, quartz, cristobalite, tridymite, coesite, and stishovite. In the case where the crystal other than the rutile crystal is included, a total content of crystal other than the rutile crystal is preferably 10 mass % or less, more preferably 7.5 mass % or less, and still more preferably 5.0 mass % or less, with respect to the entire crystallized glass. The identification of a crystal seed and the measurement of the content of the crystal other than the rutile crystal can be performed by the Rietveld analysis using the XRD measurement and the XRD measurement result described above.

### (Composition)

A composition of the crystallized glass according to Embodiment 2 is the same as a composition of an amorphous glass before crystallization to be described later. Here, the composition of the crystallized glass in the present description refers to a total composition of the composition of the crystal phase and the glass phase in the crystallized glass. The composition of the crystallized glass is determined by subjecting the crystallized glass to a heat treatment at a temperature equal to or higher than a melting point and analyzing the vitrified product. An example of the analysis method is a fluorescent X-ray analysis method. The composition of the crystal phase in the crystallized glass according to Embodiment 2 can be analyzed by the Rietveld analysis of the result obtained by the XRD measurement described above. In the composition of the crystallized glass according to Embodiment 2, a preferred lower limit of a content of a non-essential component is 0%.

It is preferable that the crystallized glass according to Embodiment 2 includes, in terms of molar percentage based on oxides, 50% to 80% of SiO₂, 0.5% to 14% of Al₂O₃, 7% to 35% of B₂O₃, 3.5% to 10% of TiO₂, 0% to 10% of MgO, 0% to 8% of CaO, and 0% to 5% of BaO, and has the total content of the alkaline earth metal oxide RO of 1% to 20%. TiO₂ is a component constituting the rutile crystal.

SiO₂ is a main component of the crystallized glass according to Embodiment 2. The content of SiO₂ is preferably 50% or more. When the content of SiO₂ is 50% or more, weather resistance can be improved and devitrification can be prevented. The content of SiO₂ is more preferably 52% or more, still more preferably 54% or more, even more preferably 55% or more, particularly preferably 56% or more, even still more preferably 57% or more, and most preferably 58% or more. In addition, the content of SiO₂ is preferably 80% or less. When the content of SiO₂ is 80% or less, the meltability of the glass raw material is improved. The content of SiO₂ is more preferably 75% or less, still more preferably 70% or less, even more preferably 68% or less, even still more preferably 66% or less, yet more preferably 65% or less, yet still more preferably 64% or less, further even more preferably 63% or less, yet still even more preferably 62% or less, particularly preferably 61% or less, and most preferably 60% or less.

Al₂O₃ is a component that prevents phase separation of the crystallized glass and that improves stability of the glass. The content of Al₂O₃ is preferably 0.5% or more. When the content of Al₂O₃ is 0.5% or more, the phase separation of the glass can be prevented, and the stability of the glass is improved. The content of Al₂O₃ is more preferably 1% or more, still more preferably 2% or more, even more preferably 3% or more, particularly preferably 3.5% or more, even still more preferably 4% or more, and most preferably 4.5% or more. In addition, the content of Al₂O₃ is preferably 14% or less, more preferably 13% or less, still more preferably 12% or less, even more preferably 11% or less, even still more preferably 10% or less, yet more preferably 9% or less, particularly preferably 8% or less, and yet still more preferably 7% or less, from the viewpoint of preventing deterioration of chemical resistance.

B₂O₃ is a component that contributes to improving the dielectric properties of the crystallized glass. The content of B₂O₃ is preferably 7% or more. When the content of B₂O₃ is 7% or more, the dielectric properties can be improved, and the meltability of the glass raw material is improved. The content of B₂O₃ is more preferably 15% or more, still more preferably 17% or more, even more preferably 18% or more, particularly preferably 19% or more, even still more preferably 20% or more, and most preferably 21% or more. In addition, the content of B₂O₃ is preferably 35% or less, more preferably 32.5% or less, still more preferably 30% or less, even more preferably 29% or less, even still more preferably 28% or less, yet more preferably 27% or less, particularly preferably 26% or less, and yet still more preferably 25% or less, from the viewpoint of preventing the deterioration of the chemical resistance.

TiO₂ is a component for precipitating the rutile crystal as a crystal phase. The content of TiO₂ is preferably 3.5% or more. When the content of TiO₂ is 3.5% or more, a desired crystal phase is easily obtained and the precipitated crystal phase of the crystallized glass is easily stabilized. The content of TiO₂ is more preferably 3.75% or more, still more preferably 4% or more, and even more preferably 4.25% or more. In addition, the content of TiO₂ is preferably 10% or less, more preferably 9% or less, still more preferably 8% or less, even more preferably 7% or less, and particularly preferably 6% or less, from the viewpoint of preventing the deterioration of the dielectric properties.

The alkaline earth metal oxide RO is a component that contributes to improving the meltability of the glass raw material. Here, RO refers to any one or more selected from MgO, CaO, SrO, and BaO. The total content of RO is preferably 1.0% or more. When the total content of RO is 1.0% or more, good meltability of the glass raw material can be obtained. The total content of RO is more preferably 1.5% or more, still more preferably 2.0% or more, even more preferably 2.5% or more, particularly preferably 3.0% or more, even still more preferably 3.5% or more, and most preferably 4% or more. In addition, the total content of RO is preferably 20% or less, more preferably 17.5% or less, still more preferably 15% or less, even more preferably 12.5% or less, particularly preferably 10% or less, and even still more preferably 8% or less, from the viewpoint of obtaining good dielectric properties.

MgO is a component that increases a Young's modulus without increasing a specific gravity, and contributes to increasing a specific elastic modulus, in addition to improving the meltability described above. In the case where MgO is included, the content thereof is preferably 1% or more, more preferably 1.5% or more, still more preferably 2.0% or more, even more preferably 2.5% or more, particularly preferably 3.0% or more, and even still more preferably 3.5% or more. In addition, the content of MgO is preferably 10% or less, more preferably 9% or less, still more preferably 8% or less, even more preferably 7% or less, particularly preferably 6% or less, and even still more preferably 5% or less, from the viewpoint of preventing a rise in devitrification temperature.

CaO is a component that increases the specific elastic modulus and that does not excessively lower a distortion point, in addition to improving the meltability described above. In the case where CaO is included, the content thereof is preferably 0.5% or more, more preferably 1% or more, still more preferably 1.5% or more, even more preferably 2% or more, particularly preferably 2.5% or more, and even still more preferably 3% or more. In addition, the content of CaO is preferably 8% or less, more preferably 7% or less, still more preferably 6% or less, even more preferably 5% or less, particularly preferably 4% or less, and even still more preferably 3% or less, from the viewpoint of preventing the rise in devitrification temperature.

SrO is a component that contributes to preventing the rise in devitrification temperature in addition to improving the meltability described above. In the case where SrO is included, the content thereof is preferably 0.5% or more, more preferably 1% or more, still more preferably 1.5% or more, even more preferably 2% or more, particularly preferably 2.5% or more, and even still more preferably 3% or more. In addition, the content of SrO is preferably 10% or less, more preferably 9% or less, still more preferably 8% or less, even more preferably 7% or less, particularly preferably 6% or less, and even still more preferably 5% or less, from the viewpoint of preventing the rise in devitrification temperature.

BaO is a component that contributes to preventing the rise in devitrification temperature in addition to improving the meltability described above. In the case where BaO is included, the content thereof is preferably 0.5% or more, more preferably 1% or more, still more preferably 1.5% or more, even more preferably 2% or more, particularly preferably 2.5% or more, and even still more preferably 3% or more. In addition, the content of BaO is preferably 5% or less, more preferably 4.5% or less, still more preferably 4% or less, and even more preferably 3.5% or less, from the viewpoint of preventing the rise in devitrification temperature.

In the crystallized glass according to Embodiment 2, a molar ratio of content represented by Al₂O₃/B₂O₃ is preferably 0.1 or more, more preferably 0.12 or more, still more preferably 0.14 or more, even more preferably 0.16 or more, particularly preferably 0.18 or more, even still more preferably 0.2 or more, and most preferably 0.3 or more, from the viewpoint of increasing the Young's modulus. When the Young's modulus is increased, warpage can be prevented in the case of using the crystallized glass as a glass substrate for a high frequency device. In addition, the molar ratio of content represented by Al₂O₃/B₂O₃ is preferably 1.4 or less, more preferably 1.3 or less, still more preferably 1.2 or less, even more preferably 1.1 or less, particularly preferably 1.0 or less, even still more preferably 0.9 or less, and most preferably 0.8 or less, from the viewpoint of improving the chemical resistance. When the chemical resistance is improved, it is possible to prevent deterioration of flatness of a glass that may occur during a chemical treatment in the case of using the crystallized glass as a glass substrate in an electronic device. The molar ratio of content represented by Al₂O₃/B₂O₃ is preferably 0.1 to 1.4.

The alkali metal oxide R₂O contributes to improving the meltability of the glass raw material, and may thus be included. Here, examples of R₂O include Li₂O, Na₂O, K₂O, Rb₂O, and Cs₂O. In the case where R₂O is included, the total content thereof is preferably 0.001% or more, more preferably 0.002% or more, still more preferably 0.003% or more, even more preferably 0.004% or more, particularly preferably 0.005% or more, and even still more preferably 0.008% or more. In addition, the total content of R₂O is preferably 3.0% or less, more preferably 2.0% or less, still more preferably 1.0% or less, and even more preferably 0.5% or less, from the viewpoint of preventing the deterioration of the dielectric properties. In the case where R₂O is included, the total content thereof is preferably 0.001% to 3.0%.

Nb₂O₃, Bi₂O₃, and Cu₂O may deteriorate the dielectric properties, and are thus preferably not included. Here, being not included means that the content of each component is at least 0.1% or less.

### Embodiment 3

In the following, a preferred crystal seed, crystallinity, and glass composition in the crystallized glass (hereinafter sometimes referred to as Embodiment 3) according to Embodiment 3 will be described.

### (Crystal)

The crystallized glass according to Embodiment 3 preferably includes a rutile crystal. Similar to Embodiment 2, the rutile crystal is a component that prevents a change in relative dielectric constant due to temperature, and is the same as Embodiment 2 in terms of a crystal composition, a crystal structure, a crystal identification method, and a mechanism for preventing the change in relative dielectric constant due to temperature.

The content of the rutile crystal is preferably 4.5 mass % or more, more preferably 5.0 mass % or more, still more preferably 5.5 mass % or more, even more preferably 6.0 mass % or more, particularly preferably 6.5 mass % or more, even still more preferably 7.0 mass % or more, and most preferably 7.5 mass % or more, with respect to the entire crystallized glass, from the viewpoint of preventing the change in relative dielectric constant due to temperature.

In addition, the content of the rutile crystal is preferably 10 mass % or less, more preferably 9.0 mass % or less, and still more preferably 8.5 mass % or less, with respect to the entire crystallized glass, from the viewpoint of preventing the deterioration of the dielectric properties. The content of the rutile crystal may be 4.5 mass % to 10 mass % with respect to the entire crystallized glass.

Further, the crystallized glass according to Embodiment 3 preferably includes at least one crystal of an indialite crystal and a cordierite crystal. The indialite crystal and the cordierite crystal are MgO—Al₂O₃—SiO₂-based crystals having the same composition but different crystal structures. Compositions of these crystals are represented by a chemical formula Mg₂Al₄Si₅O₁₈. In the case of synthesis by a solid phase reaction method, the cordierite crystal has a rectangular crystal structure, whereas the indialite crystal has a hexagonal crystal structure. Hereinafter, in the present description, at least one crystal of the indialite crystal and the cordierite crystal included in the crystallized glass may be collectively referred to as an “indialite/cordierite crystal”. That is, the “indialite/cordierite crystal” refers to either an indialite crystal or a cordierite crystal in the case where the crystallized glass includes one of the crystals, and refers to both an indialite crystal and a cordierite crystal in the case where the crystallized glass includes both the crystals.

The indialite/cordierite crystal included in the crystallized glass according to Embodiment 3 may have a hole or may have distortion. In the present description, a crystal having a hole or distortion is also called an indialite/cordierite crystal.

An insulation substrate for use in a high frequency device is required to reduce a transmission loss based on a dielectric loss, a conductor loss, and the like in order to ensure properties such as a quality and intensity of a high frequency signal. In a crystallized glass including an indialite/cordierite crystal, a dielectric loss tangent and a relative dielectric constant tend to decrease as a proportion of the crystal in the crystallized glass increases.

A total content of the indialite/cordierite crystal in the crystallized glass according to Embodiment 3 is preferably 40 mass % or more with respect to the entire crystallized glass, from the viewpoint of obtaining a crystallized glass having excellent dielectric properties. In addition, the total content of the indialite/cordierite crystal is preferably 50 mass % or more, more preferably 55 mass % or more, and still more preferably 60 mass % or more.

In addition, the total content of the indialite/cordierite crystal is preferably 90 mass % or less, more preferably 85 mass % or less, and still more preferably 80 mass % or less with respect to the entire crystallized glass, from the viewpoint of preventing cracks due to a difference in thermal expansion coefficient between the crystal phase and the glass phase, or from the viewpoint of ensuring a sufficient thermal expansion coefficient as a crystallized glass. The total content of the indialite/cordierite crystal may be 40 mass % to 90 mass % with respect to the entire crystallized glass.

Here, the indialite/cordierite crystal can be identified by X-ray diffraction measurement (XRD). Specifically, in the case where a peak having the largest intensity is confirmed in a range of 2θ=10° to 11° when the bulk body of the crystallized glass is crushed and is measured by XRD using CuKα rays at 2θ=10° to 90°, the crystallized glass includes at least one crystal of the indialite crystal and the cordierite crystal. The content of the indialite/cordierite crystal can be calculated by Rietveld analysis using a measurement result obtained by the XRD.

The crystallized glass according to Embodiment 3 may include a crystal other than the rutile crystal and the indialite/cordierite crystal as long as the effects of the present invention are not impaired. Examples of the crystal other than those described above include mullite, corundum, and anatase. In the case where the crystal other than the rutile crystal and the indialite/cordierite crystal is included, a total content of the crystal other than the rutile crystal and the indialite/cordierite crystal is preferably 15 mass % or less, more preferably 12.5 mass % or less, and still more preferably 10 mass % or less, with respect to the entire crystallized glass. The identification of a crystal seed and the measurement of the content of the crystal other than the rutile crystal and the indialite/cordierite crystal can be performed by the Rietveld analysis using the XRD measurement and the XRD measurement result described above.

### (Composition)

A composition of the present crystallized glass is the same as a composition of an amorphous glass before crystallization in a production method to be described later. Therefore, the composition of the present crystallized glass and the composition of the amorphous glass have the same preferred composition. Here, the composition of the crystallized glass in the present description refers to a total composition of the composition of the crystal phase and the glass phase in the crystallized glass. The composition of the crystallized glass is determined by subjecting the crystallized glass to a heat treatment at a temperature equal to or higher than a melting point and analyzing the vitrified product. An example of the analysis method is a fluorescent X-ray analysis method. The composition of the crystal phase in the crystallized glass according to Embodiment 3 can be analyzed by the Rietveld analysis of the result obtained by the XRD measurement described above. In the composition of the crystallized glass according to Embodiment 3, a preferred lower limit of a content of a non-essential component is 0%.

The crystallized glass according to Embodiment 3 preferably includes, in terms of molar percentage based on oxides, 51% to 70% of SiO₂, 12% to 30% of Al₂O₃, 0.5% to 10% of P₂O₅, 15% to 23% of MgO, 0% to 1.5% of CaO, and 6% to 15% of TiO₂. TiO₂ is a component constituting the rutile crystal, and SiO₂, Al₂O₃, and MgO are components constituting the indialite/cordierite crystal.

SiO₂ is a component for precipitating the indialite/cordierite crystal as a crystal phase. The content of SiO₂ is preferably 51% or more. When the content of SiO₂ is 51% or more, the precipitated crystal phase of the crystallized glass is easily stabilized. The content of SiO₂ is more preferably 51.5% or more, still more preferably 52% or more, even more preferably 52.5% or more, particularly preferably 53% or more, even still more preferably 53.5% or more, and most preferably 54% or more. In addition, the content of SiO₂ is preferably 70% or less. When the content of SiO₂ is 70% or less, it is easy to melt or mold the glass raw material. In addition, heat treatment conditions are also an important factor in order to precipitate the indialite/cordierite crystal as the crystal phase, and a wider range of the heat treatment conditions can be selected by setting the content of SiO₂ to be equal to or less than the above upper limit value. The content of SiO₂ is more preferably 65% or less, still more preferably 60% or less, even more preferably 59% or less, particularly preferably 58% or less, even still more preferably 57% or less, and most preferably 56% or less.

Al₂O₃ is a component for precipitating the indialite/cordierite crystal as a crystal phase. The content of Al₂O₃ is preferably 12% or more. When the content of Al₂O₃ is 12% or more, a desired crystal phase is easily obtained, the precipitated crystal phase of the crystallized glass is easily stabilized, and a rise in liquidus temperature can be prevented. The content of Al₂O₃ is more preferably 12.5% or more, and still more preferably 13% or more. On the other hand, the content of A₁₂O₃ is preferably 30% or less. When the content of Al₂O₃ is 30% or less, the meltability of the glass raw material is easily improved. The content of Al₂O₃ is more preferably 28% or less, still more preferably 26% or less, even more preferably 24% or less, particularly preferably 22% or less, even still more preferably 20% or less, and most preferably 18% or less.

MgO is a component for precipitating the indialite/cordierite crystal as a crystal phase. The content of MgO is preferably 15% or more. When the content of MgO is 15% or more, a desired crystal is easily obtained, the precipitated crystal phase of the crystallized glass is easily stabilized, and the meltability of the glass raw material is further improved. The content of MgO is more preferably 15% or more, still more preferably 16% or more, even more preferably 17% or more, particularly preferably 18% or more, even still more preferably 19% or more, and most preferably 20% or more. On the other hand, the content of MgO is preferably 23% or less. When the content of MgO is 23% or less, a desired crystal is easily obtained. The content of MgO is more preferably 22.5% or less, still more preferably 22% or less, and even more preferably 21.5% or less.

TiO₂ is a component for precipitating the rutile crystal as a crystal phase. The content of TiO₂ is preferably 6% or more. When the content of TiO₂ is 6% or more, a desired crystal phase is easily obtained and the precipitated crystal phase of the crystallized glass is easily stabilized. The content of TiO₂ is more preferably 6.5% or more, still more preferably 7% or more, and even more preferably 7.5% or more. In addition, the content of TiO₂ is preferably 15% or less, more preferably 14% or less, still more preferably 13% or less, and even more preferably 12% or less, from the viewpoint of preventing the deterioration of the dielectric properties.

P₂O₅ is a component that contributes to improving the meltability, moldability, and devitrification resistance of the glass raw material. The content of P₂O₅ is preferably 0.5% or more, more preferably 0.75% or more, still more preferably 1% or more, even still more preferably 1.25% or more, particularly preferably 1.5% or more, yet more preferably 1.75% or more, and most preferably 2% or more. In addition, the content of P₂O₅ is preferably 10% or less, more preferably 9% or less, still more preferably 8% or less, even more preferably 7% or less, particularly preferably 6% or less, even still more preferably 5% or less, and most preferably 4% or less, from the viewpoint of preventing separation between the crystal phase and the glass phase, and from the viewpoint of stably precipitating the crystal.

CaO may be included because of having an action of improving the meltability of the glass raw material and at the same time preventing coarsening of the precipitated crystal phase. In the case where CaO is included, the content thereof is preferably 1.5% or less, more preferably 1.25% or less, still more preferably 1% or less, even more preferably 0.8% or less, particularly preferably 0.7% or less, even still more preferably 0.6% or less, and most preferably 0.5% or less.

MoO₃ may be included because it is a component that functions as a nucleation component. The nucleation component is a component capable of generating a nucleus serving as a starting point of crystal growth when an amorphous glass is crystallized. By including the nucleation component, it is easier to stably obtain a desired crystal structure and a state where the crystal is relatively homogeneously dispersed in the crystallized glass. In the case where MoO₃ is included, the content thereof is preferably 5% or more, more preferably 5.5% or more, still more preferably 6.0% or more, even more preferably 6.5% or more, particularly preferably 7.0% or more, even still more preferably 7.5% or more, and most preferably 8.0% or more, from the viewpoint of stably precipitating a desired crystal. In addition, the content of MoO₃ is preferably 15% or less, more preferably 14.5% or less, still more preferably 14% or less, even more preferably 13.5% or less, particularly preferably 13% or less, even still more preferably 12.5% or less, and most preferably 12% or less, from the viewpoint of improving the dielectric properties.

ZrO₂ may be included because it is a component that functions as the nucleation component described above, and that contributes to refining the precipitated crystal phase, improving the mechanical strength of the material, and improving the chemical durability. In the case where ZrO₂ is included, the content thereof is preferably 5% or more, more preferably 5.5% or more, still more preferably 6.0% or more, even more preferably 6.5% or more, particularly preferably 7.0% or more, even still more preferably 7.5% or more, and most preferably 8.0% or more, from the viewpoint of stably precipitating a desired crystal. In addition, the content of ZrO₂ is preferably 15% or less, more preferably 14.5% or less, still more preferably 14% or less, even more preferably 13.5% or less, particularly preferably 13% or less, even still more preferably 12.5% or less, and most preferably 12% or less, from the viewpoint of improving the dielectric properties.

B₂O₃ may be included because it is a component that contributes to adjusting a viscosity and improving the dielectric properties during melt molding of the glass raw material. The content of B₂O₃ is preferably 0.5% or more, more preferably 0.75% or more, still more preferably 10% or more, even still more preferably 1.25% or more, particularly preferably 1.5% or more, yet more preferably 1.75% or more, and most preferably 2% or more. On the other hand, the content of B₂O₃ is preferably 10% or less, more preferably 9% or less, still more preferably 8% or less, even more preferably 7% or less, particularly preferably 6% or less, even still more preferably 5% or less, and most preferably 4% or less, from the viewpoint of preventing an excessive decrease in viscosity during crystallization and stably producing the glass.

SrO may or may not be included, but may be included in an amount of 5% or less in order to improve the meltability of the glass raw material. A more preferred range of the content of SrO is 1% or more. In addition, a more preferred range of the content of SrO is 3% or less.

BaO may or may not be included, but may be included in an amount of 5% or less in order to improve the meltability of the glass raw material. A more preferred range of the content of BaO is 1% or more. In addition, a more preferred range of the content of BaO is 3% or less.

Further, in the case where CaO, SrO, and BaO are included, it is preferable that the respective contents of CaO, SrO, and BaO satisfy a relationship CaO>SrO>BaO, from the viewpoint of obtaining good dielectric properties.

Sb₂O₃ and As₂O₃ may or may not be included, but may be included in a total of 1% or less because of acting as a refining agent when melting the glass raw material.

F may or may not be included, but may be included in an amount of 3% or less in order to improve the meltability of the glass raw material. Note that, in the present description, the content (%) of F represents the content of the F element expressed in molar percentage.

SnO₂, CeO, and Fe₂O₃ may or may not be included, but may be included in a total of 5% or less of the components in order to improve detection sensitivity of surface defects due to coloring or a colorant of the glass and to improve absorption properties of LD-pumped solid-state laser.

### Embodiment 4

In the following, a preferred crystal seed, crystallinity, and glass composition in the crystallized glass according to Embodiment 4 will be described.

### (Crystal)

The crystallized glass according to Embodiment 4 preferably includes a rutile crystal. Similar to Embodiments 2 and 3, the rutile crystal is a component that prevents a change in relative dielectric constant due to temperature, and is the same as Embodiments 2 and 3 in terms of a composition, a crystal structure, a crystal identification method, and a mechanism for preventing the change in relative dielectric constant due to temperature.

The content of the rutile crystal is preferably 2.0 mass % or more, more preferably 2.5 mass % or more, still more preferably 3.0 mass % or more, even more preferably 3.5 mass % or more, even still more preferably 4.0 mass % or more, particularly preferably 4.5 mass % or more, and most preferably 5.0 mass % or more, with respect to the entire crystallized glass, from the viewpoint of preventing the change in relative dielectric constant due to temperature.

In addition, the content of the rutile crystal is preferably 10 mass % or less, more preferably 9.0 mass % or less, and still more preferably 8.0 mass % or less, with respect to the crystallized glass, from the viewpoint of preventing the deterioration of the dielectric properties. The content of the rutile crystal may be 2.0 mass % to 10 mass % with respect to the entire crystallized glass.

Further, the crystallized glass according to Embodiment 4 preferably includes at least one crystal of a celsian crystal and a hexa-celsian crystal. The celsian crystal and the hexa-celsian crystal have the same composition but different crystal structures, and the composition thereof is represented by a chemical formula BaAl₂Si₂O₈ or SrAl₂Si₂O₈. In addition, the celsian crystal and the hexa-celsian crystal can also be precipitated as solid solutions of BaAl₂Si₂O₈ and SrAl₂Si₂O₈. Therefore, in the present description, a crystal composed of any of solid solutions of BaAl₂Si₂O₈, SrAl₂Si₂O₈, and BaAl₂Si₂O₈, and SrAl₂Si₂O₈ is referred to as the celsian crystal and the hexa-celsian crystal.

In the case of synthesis by a solid phase reaction method, the celsian crystal includes a monoclinic crystal structure, whereas the hexa-celsian crystal includes a hexagonal crystal structure. Hereinafter, in the present description, at least one crystal of the celsian crystal and the hexa-celsian crystal included in the crystallized glass may be collectively referred to as a “celsian/hexa-celsian crystal”. That is, the “celsian/hexa-celsian crystal” refers to either a celsian crystal or a hexa-celsian crystal in the case where the crystallized glass includes one of the crystals, and refers to both a celsian crystal and a hexa-celsian crystal in the case where the crystallized glass includes both the crystals.

A glass substrate for use in a high frequency device is required to reduce a transmission loss based on a dielectric loss, a conductor loss, and the like in order to ensure properties such as a quality and intensity of a high frequency signal. In a crystallized glass including a celsian/hexa-celsian crystal, a dielectric loss tangent and a relative dielectric constant tend to decrease as a proportion of the crystal in the crystallized glass increases.

A hole or distortion may be present in the celsian/hexa-celsian crystal included in the crystallized glass according to Embodiment 4. In the present description, a case where the crystal has a hole or distortion is also referred to as a celsian/hexa-celsian crystal.

In addition, the glass substrate for use in a high frequency device is also required to have a smaller difference in thermal expansion coefficient with other member (for example, a Si substrate and a Cu electrode) in the device. The crystallized glass including a celsian/hexa-celsian crystal may exhibit a thermal expansion coefficient suitable for the above application.

From the viewpoint of obtaining suitable dielectric properties and thermal expansion coefficient, a total content of the celsian/hexa-celsian crystal in the present crystallized glass is preferably 30 mass % or more, more preferably 35 mass % or more, still preferably 40 mass % or more, even more preferably 45 mass % or more, even still more preferably 50 mass % or more, particularly preferably 55 mass % or more, and most preferably 60 mass % or more, with respect to the entire crystallized glass.

In addition, from the viewpoint of obtaining suitable processing properties, the total content of the celsian/hexa-celsian crystal is preferably 90 mass % or less, more preferably 85 mass % or less, and still more preferably 80 mass % or less of the crystallized glass. The total content of the celsian/hexa-celsian crystal may be 30 mass % to 90 mass % with respect to the entire crystallized glass.

Here, the celsian/hexa-celsian crystal can be identified by X-ray diffraction measurement (XRD). Specifically, in the case where a peak having the largest intensity is confirmed in a range of 2θ=22.3° to 22.6° when bulk body of the crystallized glass is crushed and is measured by XRD using CuKα rays at 2θ=10° to 90°, the crystallized glass includes a celsian crystal. In the case where the peak having the largest intensity is confirmed in a range of 2θ=25.6 to 25.8°, the crystallized glass includes a hexa-celsian crystal. The content of the celsian/hexa-celsian crystal can be calculated by Rietveld analysis using a measurement result obtained by the XRD.

The crystallized glass according to Embodiment 4 may include a crystal other than the rutile crystal and the celsian/hexa-celsian crystal as long as the effects of the present invention are not impaired. Examples of the crystal other than the rutile crystal and the celsian/hexa-celsian crystal include mullite, corundum, and anatase. In the case where the crystal other than the rutile crystal and the celsian/hexa-celsian crystal is included, a total content of the crystal other than the rutile crystal and the celsian/hexa-celsian crystal is preferably 10 mass % or less, more preferably 8.0 mass % or less, and still more preferably 6.0 mass % or less, with respect to the entire crystallized glass. The identification of a crystal seed and the measurement of the content of the crystal other than the rutile crystal and the celsian/hexa-celsian crystal can be performed by the Rietveld analysis using the XRD measurement and the XRD measurement result described above.

### (Composition)

A composition of the crystallized glass according to Embodiment 4 is the same as a composition of an amorphous glass before crystallization in a production method to be described later. Therefore, the composition of the present crystallized glass and the composition of the amorphous glass have the same preferred composition. Here, the composition of the crystallized glass in the present description refers to a total composition of the composition of the crystal phase and the glass phase in the crystallized glass. The composition of the crystallized glass is determined by subjecting the crystallized glass to a heat treatment at a temperature equal to or higher than a melting point and analyzing the vitrified product. An example of the analysis method is a fluorescent X-ray analysis method. The composition of the crystal phase in the crystallized glass according to Embodiment 4 can be analyzed by the Rietveld analysis of the result obtained by the XRD measurement described above. In the composition of the crystallized glass according to Embodiment 4, a preferred lower limit of a content of a non-essential component is 0%.

The crystallized glass according to Embodiment 4 preferably includes, in terms of molar percentage based on oxides, 45% to 65% of SiO₂, 7.5% to 30% of Al₂O₃, 0.5% to 15% of P₂O₅, 13% to 30% of a total content of one or more selected from SrO and BaO, 2.5% to 10% of TiO₂, and 0% to 10% of ZrO₂. TiO₂ is a component constituting the rutile crystal, and SiO₂, A₁₂O₃, SrO, and BaO are components constituting the celsian/hexa-celsian crystal.

SiO₂ is a component for precipitating the celsian/hexa-celsian crystal as a crystal phase. The content of SiO₂ is preferably 45% or more. When the content of SiO₂ is 45% or more, the precipitated crystal phase of the crystallized glass is easily stabilized. The content of SiO₂ is more preferably 45.5% or more, still more preferably 46% or more, even more preferably 46.5% or more, particularly preferably 47% or more, even still more preferably 48% or more, and most preferably 50% or more. In addition, the content of SiO₂ is preferably 65% or less. When the content of SiO₂ is 65% or less, it is easy to melt or mold the glass raw material. In addition, heat treatment conditions are also an important factor in order to precipitate the celsian/hexa-celsian crystal as the crystal phase, and a wider range of the heat treatment conditions can be selected by setting the content of SiO₂ to be equal to or less than the above upper limit value. The content of SiO₂ is more preferably 62.5% or less, still more preferably 60% or less, even more preferably 57.5% or less, particularly preferably 55% or less, and even still more preferably 52.5% or less.

Al₂O₃ is a component for precipitating the celsian/hexa-celsian crystal as the crystal phase. The content of Al₂O₃ is preferably 7.5% or more. When the content of Al₂O₃ is 7.5% or more, a desired crystal phase is easily obtained, the precipitated crystal phase of the crystallized glass is easily stabilized, and a rise in liquidus temperature can be prevented. The content of Al₂O₃ is more preferably 10% or more, still more preferably 12.5% or more, even more preferably 15% or more, particularly preferably 17.5% or more, and even still more preferably 20% or more. On the other hand, the content of Al₂O₃ is preferably 30% or less. When the content of Al₂O₃ is 30% or less, the meltability of the glass raw material is easily improved. The content of Al₂O₃ is more preferably 29% or less, still more preferably 28% or less, even more preferably 27.5% or less, particularly preferably 27% or less, even still more preferably 26% or less, and most preferably 25% or less.

P₂O₅ is a component for improving the meltability of the glass raw material without deteriorating the dielectric properties of the crystallized glass. The content of P₂O₅ is preferably 0.5% or more. When the content of P₂O₅ is 0.5% or more, a desired crystal is easily obtained, the precipitated crystal phase of the crystallized glass is easily stabilized, and the meltability of the glass raw material is further improved. The content of P₂O₅ is more preferably 1% or more, still more preferably 1.5% or more, even more preferably 2% or more, and particularly preferably 2.5% or more. On the other hand, the content of P₂O₅ is preferably 15% or less. When the content of P₂O₅ is 15% or less, a desired crystal is easily obtained. The content of P₂O₅ is more preferably 8% or less, still more preferably 6% or less, and even more preferably 4% or less.

The mechanism by which P₂O₅ contributes to improving the meltability of the glass raw material in the present crystallized glass without deteriorating the dielectric properties is presumed as follows.

As a factor for improving the dielectric properties of the crystallized glass according to Embodiment 4, it is preferable that the crystal includes more Si and Al than Ba and Sr. This is presumed to be because the large amounts of Si and Al included in the crystal shorten a distance that atoms move when an electric field is applied, resulting in a decrease in relative dielectric constant. Since P has a structure very similar to Si and Al in the glass, it is thought that Si and Al move easily when the amorphous glass before crystallization is subjected to a heat treatment. Therefore, it is thought that Si and Al are easily included in the crystal, and as a result, the dielectric properties of the crystallized glass are improved.

BaO and SrO are components for precipitating the celsian/hexa-celsian crystal as the crystal phase. In order to obtain a desired crystal phase, it is sufficient to include at least one of BaO and SrO. The total content of BaO and SrO is preferably 13% or more. When the total content of BaO and SrO is 13% or more, a desired crystal is easily obtained and the precipitated crystal phase of the crystallized glass is easily stabilized. The total content of BaO and SrO is more preferably 13.5% or more, still more preferably 14% or more, even more preferably 14.5% or more, particularly preferably 15% or more, and even still more preferably 15.5% or more. On the other hand, the total content of BaO and SrO is preferably 30% or less. When the total content of BaO and SrO is 30% or less, a desired crystal can be easily obtained. The total content of BaO and SrO is more preferably 28% or less, still more preferably 26% or less, even more preferably 25% or less, particularly preferably 24% or less, and even still more preferably 23% or less.

TiO₂ is a component for precipitating the rutile crystal as a crystal phase. The content of TiO₂ is preferably 2.5% or more. When the content of TiO₂ is 2.5% or more, a desired crystal phase is easily obtained and the precipitated crystal phase of the crystallized glass is easily stabilized. The content of TiO₂ is more preferably 4% or more, still more preferably 5% or more, and even more preferably 6% or more. In addition, the content of TiO₂ is preferably 10% or less, more preferably 9% or less, and still more preferably 8% or less, from the viewpoint of preventing the deterioration of the dielectric properties.

ZrO₂ may be included because it is a component that functions as the nucleation component, and that contributes to refining the precipitated crystal phase, improving the mechanical strength of the material, and improving the chemical durability. In the case where ZrO₂ is included, the content thereof is preferably 1% or more, more preferably 1.5% or more, still more preferably 2% or more, even more preferably 2.3% or more, and particularly preferably 2.5% or more, from the viewpoint of stably precipitating a desired crystal. In addition, the content of ZrO₂ is preferably 10% or less, more preferably 8% or less, still more preferably 6% or less, even more preferably 5% or less, and particularly preferably 4% or less, from the viewpoint of improving the dielectric properties.

B₂O₃ may be included because it is a component that contributes to adjusting a viscosity and improving the dielectric properties during melt molding of the glass raw material. In the case where B₂O₃ is included, the content thereof is preferably 20% or less, more preferably 15% or less, still more preferably 10% or less, even more preferably 7.5% or less, particularly preferably 5% or less, and even still more preferably 2.5% or less.

Li₂O, Na₂O, K₂O, Rb₂O, and Cs₂O may or may not be included, but may be included in order to improve the meltability of the glass raw material. In the case where Li₂O, Na₂O, K₂O, Rb₂O, and Cs₂O are included, a total content thereof is preferably 2% or less, more preferably 1.5% or less, still more preferably 1% or less, and even more preferably 0.5% or less.

MgO and CaO may or may not be included, but may be included in order to improve the meltability of the glass raw material. In the case where MgO and CaO are included, a total content thereof is preferably 3% or less, more preferably 2.5% or less, still more preferably 2% or less, even more preferably 1.5% or less, and particularly preferably 1% or less.

ZnO may or may not be included, but may be included in order to improve the meltability of the glass raw material. In the case where ZnO is included, the content thereof is preferably 3% or less, more preferably 2.5% or less, still more preferably 2% or less, even more preferably 1.5% or less, and particularly preferably 1% or less.

Sb₂O₃ and As₂O₃ may or may not be included, but may be included in a total of 1% or less because of acting as a refining agent when melting the glass raw material.

F may or may not be included, but may be included in an amount of 3% or less in order to improve the meltability of the glass raw material. Note that, in the present description, the content (%) of F represents the content of the F element expressed in molar percentage.

SnO₂, CeO, and Fe₂O₃ may or may not be included, but may be included in a total of 5% or less of the components in order to improve detection sensitivity of surface defects due to coloring or a colorant of the glass and to improve absorption properties of LD-pumped solid-state laser.

### (Physical Properties)

The crystallized glasses according to Embodiments 1 to 4 have a dielectric loss tangent Df at 20° C. and 10 GHz of preferably 0.01 or less, more preferably 0.005 or less, still more preferably 0.004 or less, even more preferably 0.003 or less, particularly preferably 0.0025 or less, and even still more preferably 0.002 or less, from the viewpoint of improving the dielectric properties. The dielectric loss tangent at 20° C. and 10 GHz is preferably as small as possible, and is usually 0.0001 or more.

The crystallized glasses according to Embodiments 1 to 4 have a relative dielectric constant Dk at 20° C. and 10 GHz of preferably 8.5 or less, more preferably 8.0 or less, still more preferably 7.5 or less, even more preferably 7.0 or less, and particularly preferably 6.8 or less, from the viewpoint of improving the dielectric properties. The relative dielectric constant at 20° C. and 10 GHz is preferably as small as possible, and is usually 3.5 or more.

In the crystallized glasses according to Embodiments 1 to 4, when at least the dielectric loss tangent Df at 20° C. and 10 GHz is within the above preferred range, it is thought that the dielectric properties in a band of a frequency higher than 10 GHz are also excellent. It is more preferable that in addition to the dielectric loss tangent, the relative dielectric constant Dk at 20° C. and 10 GHz is within the above preferred range. The dielectric loss tangent and the relative dielectric constant can be measured using a cavity resonator and a vector network analyzer in accordance with a method defined in JIS R1641 (2007).

### (Shape)

A shape of the crystallized glasses according to Embodiments 1 to 4 is not particularly limited, and various shapes can be made according to the purpose and the application. For example, the present crystallized glass may have a plate shape including two main surfaces facing each other, or may have a shape other than the plate shape according to a product to be applied, the application, or the like. More specifically, the crystallized glasses according to Embodiments 1 to 4 may be, for example, a flat plate-shaped glass plate having no warpage or a curved glass plate having a curved surface. A shape of the main surface is not particularly limited, and can be molded into various shapes such as a circular shape and a quadrangular shape.

In the case where the crystallized glasses according to Embodiments 1 to 4 have two main surfaces facing each other, it is preferable that at least one main surface has an arithmetic average roughness Ra of 2 μm or less. When the Ra is 2 μm or less, in addition to obtaining good dielectric properties in a high frequency range, it is possible to miniaturize the crystallized glass substrate. The Ra is more preferably 1.5 μm or less, still more preferably 1 μm or less, particularly preferably 0.7 μm or less, even more preferably 0.5 μm or less, and most preferably 0.3 μm or less. The Ra is preferably as small as possible, and is usually 0.1 nm or more. The Ra can be measured by a method in accordance with JIS B0601 (2001).

An area of the main surface of the crystallized glasses according to Embodiments 1 to 4 is preferably 100 cm² or more, more preferably 225 cm² or more, and still preferably 400 cm² or more, from the viewpoint of transmission and reception efficiency in the case of using the crystallized glass in an antenna or the like. In addition, the area of the main surface is preferably 100,000 cm² or less, more preferably 10,000 cm² or less, and still more preferably 3,600 cm² or less, from the viewpoint of handleability. That is, it is preferable that the area of the largest surface of the crystallized glasses according to Embodiments 1 to 4 is within the above range. The area of the main surface of the crystallized glasses according to Embodiments 1 to 4 may be 100 cm² to 100,000 cm².

A thickness of the crystallized glasses according to Embodiments 1 to 4 is preferably 0.01 mm or more, more preferably 0.05 mm or more, and still more preferably 0.1 mm or more, from the viewpoint of maintaining the strength. The thickness of the crystallized glasses according to Embodiments 1 to 4 is preferably 2 mm or less, more preferably 1 mm or less, and still more preferably 0.7 mm or less, from the viewpoint of improving production efficiency and from the viewpoint of thinning and miniaturizing parts and products including the crystallized glasses according to Embodiments 1 to 4. The thickness of the crystallized glasses according to Embodiments 1 to 4 may be 0.01 mm to 2 mm.

### (Application)

The crystallized glasses according to Embodiments 1 to 4 are suitable for circuit boards of a high frequency device (electronic device) such as a semiconductor device for use in a communication device such as a mobile phone, a smartphone, a mobile information terminal, or a Wi-Fi device, a surface acoustic wave (SAW) device, and a radar component such as a radar transceiver, and substrates of an antenna component such as a liquid crystal antenna. The crystallized glasses according to Embodiments 1 to 4 exhibit stable dielectric properties in a high frequency range over a wide temperature range, and are thus suitable for a glass substrate for a high frequency device and a liquid crystal antenna.

### <Glass Substrate for High Frequency Device>

The crystallized glasses according to Embodiments 1 to 4 exhibit stable dielectric properties in a high frequency range over a wide temperature range, and can thus be used for a glass substrate for a high frequency device. A glass substrate for a high frequency device (hereinafter, also referred to as the present glass substrate for a high frequency device) including any of the crystallized glasses according to Embodiments 1 to 4 has the preferred relative dielectric constant and dielectric loss tangent same as those of the crystallized glasses according to Embodiments 1 to 4.

The glass substrate for a high frequency device generally includes two main surfaces facing each other. The present glass substrate for a high frequency device has an area of the main surface of preferably 75 cm² or more, more preferably 100 cm² or more, still more preferably 150 cm² or more, even more preferably 300 cm² or more, and particularly preferably 600 cm² or more, from the viewpoint of the transmission and reception efficiency. The area of the main surface of the present high frequency substrate is preferably 5,000 cm² or less, from the viewpoint of ensuring the strength. The shape can be freely designed according to the application as long as the substrate has the above area. The area of the main surface of the present glass substrate for a high frequency device may be 75 cm² to 5,000 cm².

The present glass substrate for a high frequency device has a thickness of preferably 1 mm or less, more preferably 0.8 mm or less, and still more preferably 0.7 mm or less. The thickness is preferably within the above range since the overall thickness can be reduced when a circuit is formed by laminating the substrates. On the other hand, when the thickness is preferably 0.05 mm or more, and more preferably 0.2 mm or more, the strength can be ensured. The thickness of the present glass substrate for a high frequency device may be 0.05 mm to 1 mm.

In the case where the crystallized glasses according to Embodiments 1 to 4 are used as a substrate material for a high frequency device, a hole may be formed in a crystallized glass substrate including any of the crystallized glasses according to Embodiments 1 to 4. That is, the present high frequency substrate may have a hole having an opening in at least one of the main surfaces. The hole may be a through hole communicating with the other main surface, or may be a non-penetrating void. When these holes are filled with a conductor or a conductor film is formed on a hole wall, the present glass substrate for a high frequency device may be used as a circuit.

The hole has a diameter of, for example, 200 μm or less, preferably 100 μm or less, and more preferably 50 μm or less. On the other hand, the diameter of the hole is preferably 1 μm or more. The diameter of the hole may be 1 μm to 200 μm.

A method of forming the hole is not particularly limited, and, for example, preferred method is a method of irradiating the crystallized glass substrate with laser in order to form a small hole having a diameter of 200 μm or less with high accuracy. The substrate including the present crystallized glass has excellent processability by laser irradiation. A wavelength of the laser is not particularly limited, and, for example, a wavelength of 10.6 μm or less, 3,000 nm or less, 2,050 nm or less, 1,090 nm or less, 540 nm or less, or 400 nm or less is used. In particular, in the case where the small hole having a diameter of 100 μm or less is to be formed, the following two methods are preferred.

### (Processing by UV Laser)

A hole is formed in the crystallized glass substrate by emitting UV laser having a wavelength of 400 nm or less. The UV laser is more preferably pulse-oscillation, and during laser irradiation, an absorption layer is preferably disposed on the surface of the crystallized glass substrate. After the laser irradiation, the hole may be expanded by etching the crystallized glass substrate with a hydrofluoric acid-containing solution.

### (Processing by Forming Modified Portion)

Laser having a wavelength of 400 nm to 540 nm, for example, a wavelength of about 532 nm, is emitted to form a modified portion on the crystallized glass substrate. Subsequently, the crystallized glass substrate is etched with a hydrofluoric acid-containing solution to selectively remove the modified portion to thereby form the hole. According to such a method, since the laser or the like is pulse-oscillation and the modified portion can be formed only by one shot of pulse irradiation, a hole formation rate is high and productivity is excellent.

The present glass substrate for a high frequency device is particularly suitable for a high frequency filter device for extracting an electrical signal having a specific frequency. Since filter device is required to have a function of handling radio waves having a specific frequency regardless of the environment, there is a demand for stable dielectric properties in a wide temperature range, such as those possessed by the crystallized glasses according to Embodiments 1 to 4.

### <Liquid Crystal Antenna>

A liquid crystal antenna is a satellite communication antenna capable of controlling a direction of radio waves to be transmitted and received using a liquid crystal technique, and is suitably used mainly for a vehicle such as a ship, an airplane, and an automobile. Since the liquid crystal antenna is mainly expected to be used outdoors, stable dielectric properties in a wide temperature range are required.

The crystallized glasses according to Embodiments 1 to 4 exhibit stable dielectric properties in a high frequency range over a wide temperature range, and are thus suitable for a liquid crystal antenna. A liquid crystal antenna (hereinafter, also referred to as the present liquid crystal antenna) including any of the crystallized glasses according to Embodiments 1 to 4 has preferred ranges of the relative dielectric constant and the dielectric loss tangent same as those of the crystallized glasses according to Embodiments 1 to 4.

The liquid crystal antenna generally includes two main surfaces facing each other. The present liquid crystal antenna has an area of the main surface of preferably 75 cm² or more, more preferably 100 cm² or more, still more preferably 150 cm² or more, even more preferably 300 cm² or more, and particularly preferably 700 cm² or more, from the viewpoint of the transmission and reception efficiency. The area of the main surface of the present liquid crystal antenna is preferably 10,000 cm² or less, more preferably 3,600 cm² or less, and still more preferably 2,500 cm² or less, from the viewpoint of handleability. The shape can be freely designed according to the application as long as the substrate has the above area. The area of the main surface of the present liquid crystal antenna may be 75 cm² to 10,000 cm².

The present liquid crystal antenna has a thickness of preferably 1 mm or less, more preferably 0.8 mm or less, and still more preferably 0.7 mm or less. The thickness is preferably within the above range since the overall thickness can be reduced. On the other hand, when the thickness is preferably 0.05 mm or more, and more preferably 0.2 mm or more, the strength can be ensured. The thickness of the present liquid crystal antenna may be 0.05 mm to 1 mm.

### <Crystallized Glass Production Method>

Next, a production method for the crystallized glasses according to Embodiments 1 to 4 (hereinafter, also referred to as the present production method) will be described. Hereinafter, steps in a plate-shaped glass production method will be described, and the shape of the glass can be appropriately adjusted according to the purpose.

### (Amorphous Glass Molding Step)

In the present step, a raw material blended to have a desired glass composition is melted and molded to give an amorphous glass. The melting and molding method is not particularly limited, and the glass raw material prepared by blending the glass raw material is charged into a platinum crucible, followed by charging into an electric furnace at 1,300° C. to 1,700° C., melted, defoamed, and homogenized. The obtained molten glass is poured into a metal mold (for example, a stainless steel surface plate) at room temperature, held at a temperature of a glass transition point for about 3 hours, and then cooled to room temperature to obtain a glass block of the amorphous glass. In addition, the obtained glass block is subjected to processing such as cutting, grinding, or polishing as necessary and is molded into a desired shape. Note that, the processing such as cutting, grinding, or polishing may be performed after a crystallization step. In the case where the amorphous glass is processed before the crystallization step, the shape thereof is not particularly limited, and a preferred shape is the same as the preferred shape of the present crystallized glass.

In this way, the amorphous glass can be molded into a desired shape from a molten state, and thus has advantages that it is easy to mold or easily be made into a large area, and can be produced at a low cost in view of the crystallization step to be described later, as compared with a process of molding and firing a powder or slurry, such as ceramics, or a process of producing an ingot such as synthetic quartz and then cutting the ingot into a desired shape.

### (Composition of Amorphous Glass)

The composition of the amorphous glass is not particularly limited, and preferred compositions of the amorphous glass in the case of producing the crystallized glasses according to Embodiments 2 to 4 will be described below.

In the case of producing the crystallized glass according to Embodiment 2, it is preferable that the amorphous glass includes, in terms of molar percentage based on oxides, 50% to 80% of SiO₂, 0.5% to 14% of Al₂O₃, 7% to 35% of B₂O₃, 0% to 10% of MgO, 0% to 8% of CaO, 0% to 5% of BaO, and 3.5% to 10% of TiO₂, has the total content of the alkali metal oxide R₂O of 3.0% or less, and has the total content of the alkaline earth metal oxide RO of 1% to 20%, in which Nb, Bi, and Cu are not contained in the amorphous glass. Note that, the composition of the amorphous glass is the same as the composition of the crystallized glass according to Embodiment 2 described above.

In the case of producing the crystallized glass according to Embodiment 3, the amorphous glass preferably includes, in terms of molar percentage based on oxides, 51% to 70% of SiO₂, 12% to 30% of Al₂O₃, 0.5% to 10% of P₂O₅, 15% to 23% of MgO, 0% to 1.5% of CaO, and 6% to 15% of TiO₂. Note that, the composition of the amorphous glass is the same as the composition of the crystallized glass according to Embodiment 3 described above.

In the case of producing the crystallized glass according to Embodiment 4, the amorphous glass preferably includes, in terms of molar percentage based on oxides, 45% to 65% of SiO₂, 7.5% to 30% of Al₂O₃, 0.5% to 15% of P₂O₅, 13% to 30% of a total content of one or more selected from SrO and BaO, 2.5% to 10% of TiO₂, and 0% to 10% of ZrO₂. Note that, the composition of the amorphous glass is the same as the composition of the crystallized glass according to Embodiment 4 described above.

### (Crystallization Step)

Next, the amorphous glass obtained in the amorphous glass molding step is subjected to a heat treatment. In the heat treatment, it is preferable to hold the amorphous glass at a specific treatment temperature for a specific holding time, and the treatment temperature and the holding time are not particularly limited as long as it is a condition under which a desired crystal can be precipitated. Preferred specific heat treatment conditions in the case of producing the crystallized glasses according to Embodiments 2 to 4 will be described below.

In the case of producing the crystallized glass according to Embodiment 2, the treatment temperature for the amorphous glass is, for example, preferably 750° C. or higher, more preferably 800° C. or higher, and still more preferably 850° C. or higher, from the viewpoint of promoting the precipitation of the rutile crystal, and from the viewpoint of shortening the heat treatment time and improving the productivity. On the other hand, the treatment temperature is preferably 1,200° C. or lower, more preferably 1,150° C. or lower, and still more preferably 1,100° C. or lower, from the viewpoint of the productivity.

The holding time is preferably 0.5 hours or longer, more preferably 1 hour or longer, still more preferably 2 hours or longer, and particularly preferably 3 hours or longer. When the holding time is within the above range, the crystallization sufficiently proceeds. On the other hand, since the heat treatment for a long time increases the cost required for the heat treatment, the holding time is preferably 24 hours or shorter, more preferably 12 hours or shorter, and particularly preferably 8 hours or shorter.

The heat treatment preferably includes holding at the above treatment temperature, and may further include increasing and decreasing the temperature within the range of the above treatment temperature or within another temperature range.

Specifically, for example, the temperature may be increased from room temperature to a first temperature range, held for a certain period of time, and then annealed to room temperature, and a two-stage heat treatment may be selected in which the temperature is increased from room temperature to a first temperature range and held for a certain period of time, then held for a certain period of time in a second temperature range that is higher than the first temperature range, and then annealed to room temperature.

In the case of the two-stage heat treatment, the first temperature range is preferably a temperature range in which a crystal nucleation rate increases in the glass composition. Specifically, the first temperature range is preferably 760° C. or higher, more preferably 800° C. or higher, and still more preferably 850° C. or higher. In addition, the first temperature range is preferably 960° C. or lower, more preferably 920° C. or lower, and still more preferably 880° C. or lower.

The holding time in the first temperature range is preferably 0.5 hours or longer, more preferably 1 hour or longer, still more preferably 1.5 hours or longer, and particularly preferably 2 hours or longer. When the holding time is within the above range, the nucleation is likely to proceed sufficiently. On the other hand, the holding time is preferably 5 hours or shorter, more preferably 4 hours or shorter, and particularly preferably 3 hours or shorter, from the viewpoint of preventing the progress of crystal growth simultaneously with the nucleation, and from the viewpoint of improving the dielectric properties of the entire crystallized glass.

The second temperature range is preferably a temperature range in which a crystal growth rate of a desired crystal increases. Specifically, the second temperature range is preferably 960° C. or higher, more preferably 980° C. or higher, and still more preferably 1,000° C. or higher. In addition, the second temperature range is preferably 1,100° C. or lower, and more preferably 1,050° C. or lower.

The holding time in the second temperature range is preferably 1 hour or longer, more preferably 3 hours or longer, still more preferably 5 hours or longer, and particularly preferably 6 hours or longer. When the holding time is within the above range, the crystal growth is likely to proceed sufficiently. On the other hand, the holding time is preferably 15 hours or shorter, more preferably 14 hours or shorter, and particularly preferably 12 hours or shorter, from the viewpoint of the productivity.

A temperature increase rate in the heat treatment is not particularly limited, and is generally 1° C./min or more, preferably 3° C./min or more, and more preferably 5° C./min or more, from the viewpoint of the productivity.

On the other hand, when the temperature increase rate is preferably 30° C./min or less, and more preferably 25° C./min or less, a glass having a stable shape can be produced.

A temperature decrease rate is not particularly limited, and when it is preferably 10° C./min or less, more preferably 5° C./min or less, and still more preferably 1° C./min or less, the glass is less likely to break during cooling and easily maintains the shape. On the other hand, the temperature decrease rate is generally 0.5° C./min or more.

In the case of producing the crystallized glass according to Embodiment 3, the treatment temperature for the amorphous glass is, for example, preferably 800° C. or higher, more preferably 850° C. or higher, and still more preferably 900° C. or higher, from the viewpoint of promoting the precipitation of the rutile crystal, the cordierite crystal, and the indialite crystal, and from the viewpoint of shortening the heat treatment time and improving the productivity. On the other hand, the treatment temperature is preferably 1,400° C. or lower, more preferably 1,350° C. or lower, and still more preferably 1,300° C. or lower, from the viewpoint of the productivity.

The holding time is preferably 0.25 hours or longer, more preferably 0.5 hours or longer, still more preferably 0.75 hours or longer, and particularly preferably 1 hour or longer. When the holding time is within the above range, the crystallization sufficiently proceeds. On the other hand, since the heat treatment for a long time increases the cost required for the heat treatment, the holding time is preferably 24 hours or shorter, more preferably 12 hours or shorter, and particularly preferably 8 hours or shorter.

The heat treatment preferably includes holding at the above treatment temperature, and may further include increasing and decreasing the temperature within the range of the above treatment temperature or within another temperature range.

Specifically, for example, the temperature may be increased from room temperature to a first temperature range, held for a certain period of time, and then annealed to room temperature, and a two-stage heat treatment may be selected in which the temperature is increased from room temperature to a first temperature range and held for a certain period of time, then held for a certain period of time in a second temperature range that is higher than the first temperature range, and then annealed to room temperature.

In the case of the two-stage heat treatment, the first temperature range is preferably a temperature range in which a crystal nucleation rate increases in the glass composition. Specifically, the first temperature range is preferably 760° C. or higher, more preferably 800° C. or higher, and still more preferably 850° C. or higher. In addition, the first temperature range is preferably 960° C. or lower, more preferably 920° C. or lower, and still more preferably 880° C. or lower.

The holding time in the first temperature range is preferably 0.5 hours or longer, more preferably 1 hour or longer, still more preferably 1.5 hours or longer, and particularly preferably 2 hours or longer. When the holding time is within the above range, the nucleation is likely to proceed sufficiently. On the other hand, the holding time is preferably 5 hours or shorter, more preferably 4 hours or shorter, and particularly preferably 3 hours or shorter, from the viewpoint of preventing the progress of crystal growth simultaneously with the nucleation, and from the viewpoint of improving the dielectric properties of the entire crystallized glass.

The second temperature range is preferably a temperature range in which a crystal growth rate of a desired crystal increases. Specifically, the second temperature range is preferably 960° C. or higher, more preferably 980° C. or higher, and still more preferably 1,000° C. or higher. In addition, the second temperature range is preferably 1,350° C. or lower, more preferably 1,250° C. or lower, and still more preferably 1,150° C. or lower.

The holding time in the second temperature range is preferably 0.25 hours or longer, more preferably 0.5 hours or longer, still more preferably 0.75 hours or longer, and particularly preferably 1 hour or longer. When the holding time is within the above range, the crystal growth is likely to proceed sufficiently. On the other hand, the holding time is preferably 10 hours or shorter, more preferably 8 hours or shorter, and particularly preferably 6 hours or shorter, from the viewpoint of the productivity.

A temperature increase rate in the heat treatment is not particularly limited, and is generally 1° C./min or more, preferably 3° C./min or more, and more preferably 5° C./min or more, from the viewpoint of the productivity.

On the other hand, when the temperature increase rate is preferably 30° C./min or less, and more preferably 25° C./min or less, a glass having a stable shape can be produced.

A temperature decrease rate is not particularly limited, and when it is preferably 10° C./min or less, more preferably 5° C./min or less, and still more preferably 1° C./min or less, the glass is less likely to break during cooling and easily maintains the shape. On the other hand, the temperature decrease rate is generally 0.5° C./min or more.

In the case of producing the crystallized glass according to Embodiment 4, the treatment temperature for the amorphous glass is, for example, preferably 1,050° C. or higher, more preferably 1,100° C. or higher, and still more preferably 1,150° C. or higher, from the viewpoint of promoting the precipitation of the rutile crystal, the celsian crystal, and the hexa-celsian crystal, and from the viewpoint of shortening the heat treatment time and improving the productivity. On the other hand, the treatment temperature is preferably 1,400° C. or lower, more preferably 1,350° C. or lower, and still more preferably 1,300° C. or lower, from the viewpoint of the productivity.

The holding time is preferably 0.5 hours or longer, more preferably 1 hour or longer, still more preferably 2 hours or longer, and particularly preferably 3 hours or longer. When the holding time is within the above range, the crystallization sufficiently proceeds. On the other hand, since the heat treatment for a long time increases the cost required for the heat treatment, the holding time is preferably 24 hours or shorter, more preferably 12 hours or shorter, and particularly preferably 8 hours or shorter.

The heat treatment preferably includes holding at the above treatment temperature, and may further include increasing and decreasing the temperature within the range of the above treatment temperature or within another temperature range.

Specifically, for example, the temperature may be increased from room temperature to a first temperature range, held for a certain period of time, and then annealed to room temperature, and a two-stage heat treatment may be selected in which the temperature is increased from room temperature to a first temperature range and held for a certain period of time, then held for a certain period of time in a second temperature range that is higher than the first temperature range, and then annealed to room temperature.

In the case of the two-stage heat treatment, the first temperature range is preferably a temperature range in which a crystal nucleation rate increases in the glass composition. Specifically, the first temperature range is preferably 760° C. or higher, more preferably 800° C. or higher, and still more preferably 850° C. or higher. In addition, the first temperature range is preferably 960° C. or lower, more preferably 920° C. or lower, and still more preferably 880° C. or lower.

The holding time in the first temperature range is preferably 0.5 hours or longer, more preferably 1 hour or longer, still more preferably 1.5 hours or longer, and particularly preferably 2 hours or longer. When the holding time is within the above range, the nucleation is likely to proceed sufficiently. On the other hand, the holding time is preferably 5 hours or shorter, more preferably 4 hours or shorter, and particularly preferably 3 hours or shorter, from the viewpoint of preventing the progress of crystal growth simultaneously with the nucleation, and from the viewpoint of improving the dielectric properties of the entire crystallized glass.

The second temperature range is preferably a temperature range in which a crystal growth rate of a desired crystal increases. Specifically, the second temperature range is preferably 960° C. or higher, more preferably 980° C. or higher, and still more preferably 1,000° C. or higher. In addition, the second temperature range is preferably 1,350° C. or lower, more preferably 1,250° C. or lower, and still more preferably 1,150° C. or lower.

The holding time in the second temperature range is preferably 1 hour or longer, more preferably 3 hours or longer, still more preferably 5 hours or longer, and particularly preferably 6 hours or longer. When the holding time is within the above range, the crystal growth is likely to proceed sufficiently. On the other hand, the holding time is preferably 15 hours or shorter, more preferably 14 hours or shorter, and particularly preferably 12 hours or shorter, from the viewpoint of the productivity.

A temperature increase rate in the heat treatment is not particularly limited, and is generally 1° C./min or more, preferably 3° C./min or more, and more preferably 5° C./min or more, from the viewpoint of the productivity.

On the other hand, when the temperature increase rate is preferably 30° C./min or less, and more preferably 25° C./min or less, a glass having a stable shape can be produced.

A temperature decrease rate is not particularly limited, and when it is preferably 10° C./min or less, more preferably 5° C./min or less, and still more preferably 1° C./min or less, the glass is less likely to break during cooling and easily maintains the shape. On the other hand, the temperature decrease rate is generally 0.5° C./min or more.

### EXAMPLES

Hereinafter, the present invention will be described in detail with reference to Examples, but the present invention is not limited thereto. Tables 1 to 12 show the glass composition of each of the prepared samples in terms of molar percentage based on oxides. Note that, Tables 1 to 9 correspond to the glass compositions of the crystallized glasses and amorphous glass samples according to Embodiment 2, and glasses 1 to 86 correspond to amorphous glasses in Working Examples according to Embodiment 2 and glasses 87 to 90 correspond to Comparative Examples. Tables 10 and 11 correspond to the glass compositions of the crystallized glasses and amorphous glass samples according to Embodiment 3. Table 12 corresponds to the glass compositions of the crystallized glasses and amorphous glass samples according to Embodiment 4.

The amorphous glasses having the compositions of the glasses 1 to 86 and 89 to 105 were respectively subjected to a heat treatment to give crystallized glasses. The composition, heat treatment conditions, and properties of the prepared crystallized glasses are shown in Tables 13 to 25. The composition of the crystallized glass is the same as the composition of the amorphous glass before crystallization, and is shown in Tables 13 to 25 using the glass numbers in Tables 1 to 12. Note that, Tables 13 to 22 correspond to Working Examples and Comparative Examples of the crystallized glass according to Embodiment 2. Tables 23 and 24 correspond to Working Examples and Comparative Examples of the crystallized glass according to Embodiment 3. Table 25 corresponds to Working Examples and Comparative Examples of the crystallized glass according to Embodiment 4.

The method of preparing the crystallized glasses serving as Working Examples and Comparative Examples will be specifically shown below. Glass raw materials were blended to have the compositions shown in Tables 1 to 12, and weighed to give 400 g of glass. Next, the mixed raw materials were charged into a platinum crucible, followed by charging into an electric furnace at 1,500° C. to 1,700° C., melted for about 3 hours, defoamed, and homogenized.

The obtained molten glass was poured into a metal mold, held at a temperature about 10° C. higher than the glass transition point for 1 hour, and then cooled to room temperature at a rate of 0.5° C./min, to obtain a glass block. The obtained glass block was cut, ground, and finally mirror-polished on both surfaces to obtain a glass plate having a thickness of 2 mm.

The obtained glass was subjected to a heat treatment. Specifically, the amorphous glass was heated to a temperature T1 at a predetermined temperature increase rate, held for a holding time t1, and then decreased in temperature. Note that, for some glasses, a two-stage heat treatment was performed. Specifically, the amorphous glass was heated to the temperature T1 at a first temperature increase rate, held for the holding time t1, then heated to a temperature T2 at a second temperature increase rate, held for a holding time t2, and then decreased in temperature.

Conditions such as a specific temperature in the heat treatment were set to conditions shown in Tables 13 to 25, and the heat treatment was performed to obtain the crystallized glass. In addition, physical properties described in Tables 13 to 25 were obtained from the obtained crystallized glass. Note that, in Tables 13 to 25, blanks “-” in the “crystallization condition” column indicate that the heat treatment under the corresponding condition is not performed, and blanks “-” in the “properties” column indicate that the corresponding physical property is not measured.

Methods for measuring the physical properties are shown below.

### (PXRD Measurement and Rietveld Analysis)

The obtained crystallized glass was subjected to PXRD measurement by the following procedure to identify a crystal seed.

### (PXRD Measurement Sample Preparation Conditions)

A crystallized glass plate subjected to a SPDR method was crushed using an agate mortar and an agate pestle, to obtain a powder for PXRD measurement.

### (PXRD Measurement Conditions)

Powder X-ray diffraction was measured under the following conditions to identify the precipitated crystal.

For identification of the crystal seed, a diffraction peak pattern recorded in an ICSD inorganic crystal structure database and an ICDD powder diffraction database was used.
Measurement device: SmartLab manufactured by Rigaku Corporation
Measurement method: concentration method
Tube voltage: 45 kV
Tube current: 200 mA
X-ray used: CuKα ray
Measurement range: 2θ=10° to 80°
Speed: 10°/min
Step: 0.02°

### (Rietveld Measurement Sample Preparation Conditions)

A crystallized glass powder used in the PXRD measurement was passed through a mesh having an opening of 500 μm, and then ZnO was added as a standard substance so as to be 10 mass % of the entire sample.

### (Rietveld Analysis Conditions)

The powder X-ray diffraction was measured under the following conditions, and the Rietveld analysis was performed using the obtained results.
Measurement device: SmartLab manufactured by Rigaku Corporation
Measurement method: concentration method
Tube voltage: 45 kV
Tube current: 200 mA
X-ray used: CuKα ray
Measurement range: 2θ=10° to 90°
Speed: 5°/min
Step: 0.01°

A powder X-ray diffraction profile obtained under the above conditions was analyzed using a Rietveld analysis program: Rietan FP. The analysis of each sample was converged such that Rwp representing a quality of analysis convergence was 10 or less. The Rietveld method is described in “Crystal Analysis Handbook” edited by the Crystallographic Society of Japan Editing Committee of “Crystal Analysis Handbook” (Kyoritsu Shuppan, 1999, p492 to 499).

### (Crystallinity Calculation)

Calculation was performed such that the added 10 mass % of ZnO was subtracted from a weight ratio of a crystal phase obtained by the Rietveld analysis and a residual glass phase obtained by subtracting the content of the crystal phase from the total amount of the measurement sample, and the remaining phase was 100 mass % in total.

### (Relative Dielectric Constant Dk and Dielectric Loss Tangent Df at 10 GHz)

The relative dielectric constant Dk and the dielectric loss tangent Df at 10 GHz were measured using a network analyzer by a slip post dielectric resonance method (SPDR method). As a sample, a sample obtained by processing a crystallized glass plate after the heat treatment into 35 mm×35 mm×0.5 mm was used.

### (Measurement of Rate of Change ΔDk in Relative Dielectric Constant at 10 GHz Due to Temperature)

The measurement was performed using a cavity resonator and a vector network analyzer in accordance with a method defined in JIS R1641 (2007). The measurement frequency was 10 GHz, and the measurement temperatures were −20° C., 0° C., 20° C., 40° C., and 60° C. As a sample, a sample obtained by processing a crystallized glass plate after the heat treatment into 35 mm×35 mm×0.5 mm was used.

### (Measurement of Ra)

The measurement was performed using a laser microscope VK-X200 manufactured by Keyence Corporation by a method in accordance with JIS B0601 (2001).

TABLE 1

| (mol %) | Glass 1 | Glass 2 | Glass 3 | Glass 4 | Glass 5 | Glass 6 | Glass 7 | Glass 8 | Glass 9 | Glass 10 |
|---|---|---|---|---|---|---|---|---|---|---|
| SiO₂ | 62.9 | 59.5 | 59.4 | 71.1 | 68.9 | 66.4 | 63.7 | 61.6 | 59.1 | 62.1 |
| Al₂O₃ | 11.0 | 8.2 | 8.2 | 3.8 | 3.8 | 3.8 | 3.8 | 3.8 | 3.8 | 4.8 |
| B₂O₃ | 7.2 | 20.5 | 20.3 | 17.3 | 19.2 | 21.0 | 23.9 | 26.4 | 28.7 | 23.9 |
| P₂O₅ | 0.0 | 0.0 | 0.0 | 0.0 | 0.0 | 0.0 | 0.0 | 0.0 | 0.0 | 0.0 |
| MgO | 5.0 | 0.2 | 0.2 | 3.1 | 3.6 | 3.6 | 3.6 | 3.1 | 3.1 | 3.8 |
| CaO | 4.2 | 0.2 | 0.2 | 0.0 | 0.0 | 0.0 | 0.0 | 0.0 | 0.0 | 0.0 |
| SrO | 4.9 | 6.8 | 6.7 | 0.0 | 0.2 | 0.2 | 0.2 | 0.8 | 0.8 | 0.8 |
| BaO | 0.1 | 1.1 | 1.1 | 0.8 | 0.2 | 0.2 | 0.2 | 0.2 | 0.2 | 0.2 |
| Li₂O | 0.0 | 0.0 | 0.0 | 0.0 | 0.0 | 0.0 | 0.0 | 0.0 | 0.0 | 0.2 |
| Na₂O | 0.0 | 0.0 | 0.0 | 0.0 | 0.0 | 0.1 | 0.0 | 0.0 | 0.0 | 0.0 |
| K₂O | 0.0 | 0.0 | 0.0 | 0.0 | 0.0 | 0.0 | 0.0 | 0.0 | 0.0 | 0.0 |
| TiO₂ | 4.8 | 3.5 | 4.0 | 3.8 | 4.0 | 4.8 | 4.5 | 4.1 | 4.2 | 4.2 |
| Sum | 100.0 | 100.0 | 100.0 | 100.0 | 100.0 | 100.0 | 100.0 | 100.0 | 100.0 | 100.0 |

TABLE 2

| (mol %) | Glass 11 | Glass 12 | Glass 13 | Glass 14 | Glass 15 | Glass 16 | Glass 17 | Glass 18 | Glass 19 | Glass 20 |
|---|---|---|---|---|---|---|---|---|---|---|
| SiO₂ | 56.7 | 56.9 | 59.3 | 60.0 | 62.5 | 63.7 | 60.7 | 59.5 | 58.9 | 59.5 |
| Al₂O₃ | 3.8 | 5.7 | 3.8 | 4.8 | 2.9 | 2.9 | 5.7 | 5.7 | 4.8 | 3.8 |
| B₂O₃ | 31.1 | 28.5 | 28.8 | 26.9 | 26.9 | 24.9 | 23.7 | 26.5 | 26.9 | 28.9 |
| P₂O₅ | 0.0 | 0.0 | 0.0 | 0.0 | 0.0 | 0.0 | 0.0 | 0.0 | 0.0 | 0.0 |
| MgO | 3.1 | 3.0 | 3.8 | 1.4 | 1.9 | 1.9 | 1.9 | 0.9 | 3.4 | 0.0 |
| CaO | 0.0 | 0.0 | 0.0 | 1.9 | 1.4 | 1.9 | 1.9 | 0.9 | 1.0 | 3.1 |
| SrO | 0.8 | 0.8 | 0.0 | 1.0 | 0.5 | 0.5 | 0.8 | 0.9 | 1.0 | 0.8 |
| BaO | 0.2 | 0.2 | 0.0 | 0.0 | 0.0 | 0.0 | 0.2 | 0.2 | 0.2 | 0.2 |
| Li₂O | 0.0 | 0.0 | 0.1 | 0.0 | 0.0 | 0.0 | 0.0 | 0.0 | 0.2 | 0.0 |
| Na₂O | 0.0 | 0.0 | 0.0 | 0.0 | 0.0 | 0.1 | 0.0 | 0.0 | 0.0 | 0.0 |
| K₂O | 0.0 | 0.0 | 0.0 | 0.0 | 0.0 | 0.0 | 0.0 | 0.0 | 0.0 | 0.0 |
| TiO₂ | 4.3 | 4.9 | 4.1 | 3.9 | 3.8 | 4.1 | 5.0 | 5.2 | 3.7 | 3.8 |
| Sum | 100.0 | 100.0 | 100.0 | 100.0 | 100.0 | 100.0 | 100.0 | 100.0 | 100.0 | 100.0 |

TABLE 3

| (mol %) | Glass 21 | Glass 22 | Glass 23 | Glass 24 | Glass 25 | Glass 26 | Glass 27 | Glass 28 | Glass 29 | Glass 30 |
|---|---|---|---|---|---|---|---|---|---|---|
| SiO₂ | 59.4 | 58.9 | 63.3 | 57.2 | 57.8 | 57.5 | 59.2 | 58.7 | 59.4 | 58.0 |
| Al₂O₃ | 3.8 | 3.8 | 10.8 | 4.8 | 1.9 | 3.8 | 3.8 | 3.7 | 3.8 | 3.8 |
| B₂O₃ | 28.8 | 28.6 | 7.4 | 26.7 | 29.9 | 28.8 | 28.8 | 27.4 | 28.7 | 28.2 |
| P₂O₅ | 0.0 | 0.0 | 0.0 | 0.0 | 0.0 | 0.0 | 0.0 | 0.0 | 0.0 | 0.0 |
| MgO | 0.0 | 0.0 | 4.9 | 1.9 | 1.9 | 3.1 | 1.9 | 3.0 | 3.1 | 3.0 |
| CaO | 0.0 | 0.2 | 4.3 | 2.9 | 2.9 | 1.9 | 1.2 | 0.4 | 0.2 | 0.2 |
| SrO | 3.8 | 0.8 | 5.0 | 1.9 | 1.9 | 0.8 | 0.8 | 0.9 | 0.6 | 0.6 |
| BaO | 0.2 | 3.1 | 0.0 | 0.0 | 0.0 | 0.2 | 0.2 | 0.2 | 0.2 | 0.2 |
| Li₂O | 0.0 | 0.1 | 0.0 | 0.0 | 0.0 | 0.0 | 0.2 | 0.1 | 0.5 | 0.3 |
| Na₂O | 0.0 | 0.0 | 0.0 | 0.0 | 0.0 | 0.0 | 0.0 | 0.0 | 0.0 | 0.0 |
| K₂O | 0.0 | 0.0 | 0.0 | 0.0 | 0.0 | 0.0 | 0.0 | 0.0 | 0.0 | 0.0 |
| TiO₂ | 3.8 | 4.5 | 4.3 | 4.7 | 3.7 | 3.8 | 3.9 | 5.6 | 3.6 | 5.7 |
| Sum | 100.0 | 100.0 | 100.0 | 100.0 | 100.0 | 100.0 | 100.0 | 100.0 | 100.0 | 100.0 |

TABLE 4

| (mol %) | Glass 31 | Glass 32 | Glass 33 | Glass 34 | Glass 35 | Glass 36 | Glass 37 | Glass 38 | Glass 39 | Glass 40 |
|---|---|---|---|---|---|---|---|---|---|---|
| SiO₂ | 57.8 | 59.0 | 59.8 | 58.1 | 58.7 | 58.5 | 58.6 | 59.2 | 57.7 | 58.2 |
| Al₂O₃ | 3.7 | 2.9 | 4.1 | 3.6 | 3.6 | 3.6 | 2.9 | 3.8 | 4.0 | 3.4 |
| B₂O₃ | 28.1 | 28.6 | 27.0 | 28.3 | 28.6 | 28.6 | 28.8 | 28.8 | 28.0 | 28.0 |
| P₂O₅ | 0.0 | 0.0 | 0.0 | 0.0 | 0.0 | 0.0 | 0.0 | 0.0 | 0.0 | 0.0 |
| MgO | 3.0 | 2.7 | 2.9 | 0.9 | 1.0 | 1.0 | 1.9 | 1.9 | 3.2 | 3.9 |
| CaO | 0.2 | 1.0 | 0.2 | 3.3 | 0.2 | 0.2 | 1.9 | 1.2 | 0.9 | 0.6 |
| SrO | 0.6 | 1.0 | 0.6 | 0.2 | 3.2 | 0.2 | 1.9 | 0.8 | 0.8 | 1.0 |
| BaO | 0.2 | 0.2 | 0.2 | 0.0 | 0.2 | 3.1 | 0.0 | 0.2 | 0.2 | 0.2 |
| Li₂O | 0.9 | 0.1 | 0.3 | 0.3 | 0.3 | 0.3 | 0.2 | 0.3 | 0.3 | 0.3 |
| Na₂O | 0.0 | 0.0 | 0.0 | 0.0 | 0.0 | 0.0 | 0.0 | 0.0 | 0.1 | 0.1 |
| K₂O | 0.0 | 0.0 | 0.0 | 0.0 | 0.0 | 0.0 | 0.0 | 0.0 | 0.0 | 0.0 |
| TiO₂ | 5.4 | 4.7 | 4.8 | 5.3 | 4.2 | 4.5 | 3.7 | 3.8 | 4.8 | 4.4 |
| Sum | 100.0 | 100.0 | 100.0 | 100.0 | 100.0 | 100.0 | 100.0 | 100.0 | 100.0 | 100.0 |

TABLE 5

| (mol %) | Glass 41 | Glass 42 | Glass 43 | Glass 44 | Glass 45 | Glass 46 | Glass 47 | Glass 48 | Glass 49 | Glass 50 |
|---|---|---|---|---|---|---|---|---|---|---|
| SiO₂ | 58.2 | 58.8 | 58.6 | 58.6 | 58.6 | 58.2 | 57.8 | 61.0 | 60.8 | 61.1 |
| Al₂O₃ | 4.1 | 3.9 | 4.6 | 5.3 | 4.6 | 4.0 | 3.9 | 8.6 | 9.1 | 8.6 |
| B₂O₃ | 27.8 | 27.7 | 27.4 | 27.3 | 26.5 | 28.4 | 27.5 | 17.6 | 17.7 | 18.2 |
| P₂O₅ | 0.0 | 0.0 | 0.0 | 0.0 | 0.0 | 0.0 | 0.0 | 0.0 | 0.0 | 0.0 |
| MgO | 3.2 | 3.8 | 3.6 | 3.0 | 3.4 | 0.9 | 3.8 | 3.8 | 2.4 | 2.4 |
| CaO | 1.0 | 1.1 | 1.2 | 0.9 | 0.9 | 0.5 | 0.9 | 3.3 | 3.3 | 3.3 |
| SrO | 0.8 | 0.8 | 0.7 | 0.7 | 0.7 | 0.8 | 0.8 | 0.8 | 2.2 | 1.7 |
| BaO | 0.2 | 0.0 | 0.0 | 0.0 | 0.1 | 1.9 | 0.2 | 0.2 | 0.2 | 0.2 |
| Li₂O | 0.3 | 0.0 | 0.0 | 0.0 | 0.0 | 0.3 | 0.3 | 0.0 | 0.0 | 0.0 |
| Na₂O | 0.1 | 0.0 | 0.0 | 0.1 | 0.0 | 0.0 | 0.1 | 0.0 | 0.0 | 0.1 |
| K₂O | 0.0 | 0.0 | 0.0 | 0.0 | 0.0 | 0.0 | 0.0 | 0.0 | 0.0 | 0.0 |
| TiO₂ | 4.3 | 3.8 | 4.0 | 4.3 | 5.2 | 5.0 | 4.8 | 4.8 | 4.3 | 4.3 |
| Sum | 100.0 | 100.0 | 100.0 | 100.0 | 100.0 | 100.0 | 100.0 | 100.0 | 100.0 | 100.0 |

TABLE 6

| (mol %) | Glass 51 | Glass 52 | Glass 53 | Glass 54 | Glass 55 | Glass 56 | Glass 57 | Glass 58 | Glass 59 | Glass 60 |
|---|---|---|---|---|---|---|---|---|---|---|
| SiO₂ | 58.4 | 59.0 | 60.9 | 59.7 | 59.9 | 60.0 | 60.5 | 60.7 | 60.8 | 62.1 |
| Al₂O₃ | 8.6 | 7.6 | 8.2 | 9.0 | 9.0 | 9.0 | 9.0 | 9.1 | 9.5 | 9.1 |
| B₂O₃ | 21.0 | 18.1 | 18.8 | 17.5 | 17.5 | 16.6 | 15.7 | 14.8 | 16.2 | 16.4 |
| P₂O₅ | 0.0 | 0.0 | 0.0 | 0.0 | 0.0 | 0.0 | 0.0 | 0.0 | 0.0 | 0.0 |
| MgO | 3.8 | 3.8 | 2.4 | 3.3 | 2.8 | 2.8 | 2.9 | 3.3 | 1.0 | 1.0 |
| CaO | 2.9 | 1.9 | 3.4 | 3.3 | 3.3 | 3.3 | 3.8 | 4.3 | 5.7 | 5.8 |
| SrO | 0.8 | 1.0 | 2.2 | 1.7 | 1.7 | 2.7 | 3.1 | 3.2 | 1.9 | 1.9 |
| BaO | 0.2 | 3.8 | 0.2 | 0.2 | 0.2 | 0.2 | 0.2 | 0.2 | 0.0 | 0.0 |
| Li₂O | 0.0 | 0.1 | 0.0 | 0.0 | 0.0 | 0.0 | 0.0 | 0.0 | 0.0 | 0.0 |
| Na₂O | 0.0 | 0.0 | 0.1 | 0.0 | 0.0 | 0.2 | 0.0 | 0.0 | 0.0 | 0.0 |
| K₂O | 0.0 | 0.0 | 0.0 | 0.0 | 0.0 | 0.0 | 0.0 | 0.0 | 0.0 | 0.0 |
| TiO₂ | 4.3 | 4.8 | 3.8 | 5.2 | 5.7 | 5.2 | 4.8 | 4.4 | 4.9 | 3.8 |
| Sum | 100.0 | 100.0 | 100.0 | 100.0 | 100.0 | 100.0 | 100.0 | 100.0 | 100.0 | 100.0 |

TABLE 7

| (mol %) | Glass 61 | Glass 62 | Glass 63 | Glass 64 | Glass 65 | Glass 66 | Glass 67 | Glass 68 | Glass 69 | Glass 70 |
|---|---|---|---|---|---|---|---|---|---|---|
| SiO₂ | 59.4 | 59.2 | 59.5 | 59.4 | 59.5 | 59.6 | 60.1 | 61.2 | 60.2 | 60.7 |
| Al₂O₃ | 10.5 | 10.5 | 10.5 | 10.4 | 10.6 | 10.6 | 8.0 | 9.1 | 9.6 | 8.2 |
| B₂O₃ | 16.3 | 16.2 | 16.2 | 16.1 | 16.3 | 16.3 | 18.9 | 16.3 | 16.2 | 19.2 |
| P₂O₅ | 0.0 | 0.0 | 0.0 | 0.0 | 0.0 | 0.0 | 0.0 | 0.0 | 0.0 | 0.0 |
| MgO | 2.9 | 2.9 | 2.9 | 2.8 | 3.8 | 4.8 | 5.7 | 7.7 | 7.6 | 6.7 |
| CaO | 5.4 | 5.6 | 5.1 | 5.8 | 4.7 | 3.7 | 0.9 | 0.5 | 1.0 | 0.3 |
| SrO | 0.2 | 0.2 | 0.2 | 0.2 | 0.2 | 0.2 | 0.8 | 0.8 | 0.8 | 0.8 |
| BaO | 1.1 | 0.9 | 0.9 | 0.2 | 0.9 | 0.9 | 0.2 | 0.2 | 0.2 | 0.2 |
| Li₂O | 0.0 | 0.0 | 0.0 | 0.0 | 0.0 | 0.0 | 0.0 | 0.0 | 0.0 | 0.0 |
| Na₂O | 0.0 | 0.0 | 0.0 | 0.0 | 0.0 | 0.0 | 0.0 | 0.0 | 0.0 | 0.0 |
| K₂O | 0.0 | 0.0 | 0.0 | 0.0 | 0.0 | 0.0 | 0.0 | 0.0 | 0.0 | 0.0 |
| TiO₂ | 4.2 | 4.6 | 4.9 | 5.0 | 4.0 | 3.9 | 5.4 | 4.3 | 4.5 | 4.0 |
| Sum | 100.0 | 100.0 | 100.0 | 100.0 | 100.0 | 100.0 | 100.0 | 100.0 | 100.0 | 100.0 |

TABLE 8

| (mol %) | Glass 71 | Glass 72 | Glass 73 | Glass 74 | Glass 75 | Glass 76 | Glass 77 | Glass 78 | Glass 79 | Glass 80 |
|---|---|---|---|---|---|---|---|---|---|---|
| SiO₂ | 60.2 | 60.3 | 59.8 | 59.4 | 60.1 | 58.9 | 58.5 | 60.2 | 59.7 | 58.7 |
| Al₂O₃ | 7.9 | 7.7 | 7.9 | 7.9 | 8.1 | 8.0 | 8.0 | 9.6 | 9.5 | 8.5 |
| B₂O₃ | 19.0 | 19.0 | 19.0 | 19.0 | 19.1 | 18.9 | 19.9 | 16.3 | 16.1 | 20.0 |
| P₂O₅ | 0.0 | 0.0 | 0.0 | 0.0 | 0.0 | 0.0 | 0.0 | 0.0 | 0.0 | 0.0 |
| MgO | 6.6 | 6.6 | 6.7 | 6.7 | 6.7 | 6.6 | 0.2 | 3.3 | 5.7 | 0.6 |
| CaO | 0.3 | 0.3 | 0.8 | 1.2 | 0.2 | 0.2 | 0.2 | 0.2 | 0.2 | 0.2 |
| SrO | 0.8 | 0.8 | 0.8 | 0.8 | 0.2 | 0.2 | 6.6 | 5.9 | 0.2 | 6.6 |
| BaO | 0.2 | 0.2 | 0.2 | 0.2 | 1.0 | 1.5 | 1.0 | 0.2 | 3.4 | 0.2 |
| Li₂O | 0.0 | 0.0 | 0.0 | 0.0 | 0.0 | 0.0 | 0.0 | 0.1 | 0.0 | 0.0 |
| Na₂O | 0.0 | 0.0 | 0.0 | 0.0 | 0.0 | 0.0 | 0.0 | 0.0 | 0.0 | 0.0 |
| K₂O | 0.0 | 0.0 | 0.0 | 0.0 | 0.0 | 0.0 | 0.0 | 0.0 | 0.0 | 0.0 |
| TiO₂ | 5.0 | 5.1 | 4.9 | 4.9 | 4.7 | 5.7 | 5.5 | 4.3 | 5.2 | 5.1 |
| Sum | 100.0 | 100.0 | 100.0 | 100.0 | 100.0 | 100.0 | 100.0 | 100.0 | 100.0 | 100.0 |

TABLE 9

| (mol %) | Glass 81 | Glass 82 | Glass 83 | Glass 84 | Glass 85 | Glass 86 | Glass 87 | Glass 88 | Glass 89 | Glass 90 |
|---|---|---|---|---|---|---|---|---|---|---|
| SiO₂ | 59.1 | 59.5 | 62.8 | 59.2 | 58.7 | 57.0 | 66.0 | 61.9 | 60.7 | 58.8 |
| Al₂O₃ | 7.6 | 10.4 | 10.7 | 7.6 | 7.7 | 4.7 | 11.5 | 8.5 | 8.3 | 8.1 |
| B₂O₃ | 18.1 | 16.1 | 7.4 | 22.0 | 22.1 | 26.6 | 7.6 | 21.1 | 20.7 | 13.0 |
| P₂O₅ | 0.0 | 0.0 | 0.0 | 0.0 | 0.0 | 0.0 | 0.0 | 0.0 | 0.0 | 0.0 |
| MgO | 3.8 | 2.8 | 4.9 | 3.8 | 3.8 | 1.9 | 5.2 | 0.2 | 0.2 | 0.2 |
| CaO | 1.9 | 5.3 | 4.3 | 1.9 | 1.9 | 2.8 | 4.4 | 0.2 | 0.2 | 0.2 |
| SrO | 1.0 | 0.2 | 4.9 | 0.8 | 0.8 | 1.9 | 5.1 | 7.0 | 6.9 | 6.7 |
| BaO | 3.8 | 0.2 | 0.0 | 0.2 | 0.2 | 0.0 | 0.1 | 1.1 | 1.1 | 1.0 |
| Li₂O | 0.0 | 0.0 | 0.0 | 0.0 | 0.0 | 0.0 | 0.0 | 0.0 | 0.0 | 0.0 |
| Na₂O | 0.0 | 0.0 | 0.0 | 0.0 | 0.8 | 0.0 | 0.0 | 0.0 | 0.0 | 0.0 |
| K₂O | 0.0 | 0.0 | 0.0 | 0.0 | 0.0 | 0.0 | 0.0 | 0.0 | 0.0 | 0.0 |
| TiO₂ | 4.7 | 5.6 | 5.0 | 4.5 | 4.1 | 5.0 | 0.0 | 0.0 | 2.0 | 12.0 |
| Sum | 100.0 | 100.0 | 100.0 | 100.0 | 100.0 | 100.0 | 100.0 | 100.0 | 100.0 | 100.0 |

TABLE 10

| (mol %) | Glass 91 | Glass 92 | Glass 93 | Glass 94 | Glass 95 | Glass 96 | Glass 97 | Glass 98 | Glass 99 | Glass 100 |
|---|---|---|---|---|---|---|---|---|---|---|
| SiO₂ | 54.5 | 55.5 | 60.0 | 52.5 | 51.0 | 58.0 | 64.0 | 54.0 | 53.0 | 56.0 |
| Al₂O₃ | 13.0 | 13.0 | 15.0 | 20.0 | 17.0 | 12.5 | 12.0 | 12.0 | 14.0 | 13.5 |
| B₂O₃ | 0.0 | 0.0 | 0.0 | 0.0 | 0.0 | 0.0 | 0.0 | 0.5 | 4.5 | 0.0 |
| P₂O₅ | 2.0 | 0.5 | 0.5 | 1.5 | 3.5 | 1.0 | 1.0 | 2.0 | 1.5 | 1.5 |
| MgO | 21.0 | 22.5 | 15.0 | 17.0 | 19.0 | 20.0 | 15.0 | 22.0 | 19.0 | 21.0 |
| CaO | 0.0 | 0.0 | 0.0 | 1.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 | 0.0 | 0.0 | 0.0 |
| Na₂O | 0.0 | 0.0 | 0.0 | 0.0 | 0.0 | 0.0 | 0.0 | 0.0 | 0.0 | 0.0 |
| K₂O | 0.0 | 0.0 | 0.0 | 0.0 | 0.0 | 0.0 | 0.0 | 0.0 | 0.0 | 0.0 |
| TiO₂ | 9.5 | 8.5 | 9.5 | 8.0 | 9.5 | 8.5 | 8.0 | 9.5 | 8.0 | 8.0 |
| Sum | 100.0 | 100.0 | 100.0 | 100.0 | 100.0 | 100.0 | 100.0 | 100.0 | 100.0 | 100.0 |

TABLE 11

| (mol %) | Glass 101 | Glass 102 |
|---|---|---|
| SiO₂ | 55.0 | 53.8 |
| Al₂O₃ | 15.0 | 20.6 |
| B₂O₃ | 0.0 | 0.0 |
| P₂O₅ | 1.0 | 0.0 |
| MgO | 20.0 | 20.6 |
| CaO | 0.0 | 0.0 |
| SrO | 0.0 | 0.0 |
| BaO | 0.0 | 0.0 |
| Li₂O | 0.0 | 0.0 |
| Na₂O | 0.0 | 0.0 |
| K₂O | 0.0 | 0.0 |
| TiO₂ | 9.0 | 5.0 |
| Sum | 100.0 | 100.0 |

TABLE 12

| (mol %) | Glass 103 | Glass 104 | Glass 105 |
|---|---|---|---|
| SiO₂ | 46.4 | 52.0 | 45.8 |
| Al₂O₃ | 25.0 | 21.0 | 26.6 |
| B₂O₃ | 0.0 | 0.0 | 0.0 |
| P₂O₅ | 2.4 | 2.4 | 3.0 |
| MgO | 0.0 | 0.0 | 0.0 |
| CaO | 0.0 | 0.0 | 0.0 |
| SrO | 0.0 | 17.6 | 0.0 |
| BaO | 19.2 | 0.0 | 19.6 |
| Li₂O | 0.0 | 0.0 | 0.0 |
| Na₂O | 0.0 | 0.0 | 0.0 |
| K₂O | 0.0 | 0.0 | 0.0 |
| TiO₂ | 7.2 | 7.0 | 0.0 |
| ZrO₂ | 0.0 | 0.0 | 5.0 |
| Sum | 100.0 | 100.0 | 100.0 |

TABLE 13

| | Example | Example | Example | Example | Example | Example | Example | Example | Example | Example |
|---|---|---|---|---|---|---|---|---|---|---|
| | 1 | 2 | 3 | 4 | 5 | 6 | 7 | 8 | 9 | 10 |
| Working Example | Working | Working | Working | Working | Working | Working | Working | Working | Working | Working |
| or Comparative | Example | Example | Example | Example | Example | Example | Example | Example | Example | Example |
| Example | | | | | | | | | | |
| Glass number | 1 | 2 | 3 | 4 | 5 | 6 | 7 | 8 | 9 | 10 |
| (composition) | | | | | | | | | | |
| Crystallization | | | | | | | | | | |
| conditions | | | | | | | | | | |
| Heating rate to T1 | 5 | 5 | 5 | 5 | 5 | 5 | 5 | 5 | 5 | 5 |
| [° C./min] | | | | | | | | | | |
| Temperature T1 | 900 | 900 | 900 | 900 | 900 | 900 | 900 | 900 | 900 | 900 |
| [° C.] | | | | | | | | | | |
| Holding time t1 [h] | 4.0 | 4.0 | 4.0 | 4.0 | 4.0 | 4.0 | 4.0 | 4.0 | 4.0 | 4.0 |
| Heating rate to T2 | — | — | — | — | — | — | — | — | — | — |
| [° C./min] | | | | | | | | | | |
| Temperature T2 | — | — | — | — | — | — | — | — | — | — |
| [° C.] | | | | | | | | | | |
| Holding time t2 [h] | — | — | — | — | — | — | — | — | — | — |
| Crystal seed | | | | | | | | | | |
| Rutile crystal | 5.0% | 0.7% | 4.3% | 3.5% | 4.5% | 5.0% | 5.0% | 4.5% | 4.0% | 4.0% |
| [mass %] | | | | | | | | | | |
| Properties | | | | | | | | | | |
| Dk @ 10 GHz | 6.6 | 5.1 | 5.8 | 4.8 | 4.9 | 5.0 | 5.0 | 4.9 | 4.8 | 4.9 |
| Df @ 10 GHz | 0.0070 | 0.0028 | 0.0027 | 0.0017 | 0.0016 | 0.0016 | 0.0015 | 0.0015 | 0.0014 | 0.0016 |
| ΔDk @ 10 GHz | −2 | 43 | −48 | −20 | −34 | −41 | −39 | −31 | −22 | −25 |
| Ra [μm] | 0.1 | 0.09 | 0.1 | 0.07 | 0.09 | 0.1 | 0.1 | 0.09 | 0.08 | 0.08 |

TABLE 14

| | Example | Example | Example | Example | Example | Example | Example | Example | Example | Example |
|---|---|---|---|---|---|---|---|---|---|---|
| | 11 | 12 | 13 | 14 | 15 | 16 | 17 | 18 | 19 | 20 |
| Working Example | Working | Working | Working | Working | Working | Working | Working | Working | Working | Working |
| or Comparative | Example | Example | Example | Example | Example | Example | Example | Example | Example | Example |
| Example | | | | | | | | | | |
| Glass number | 11 | 12 | 13 | 14 | 15 | 16 | 17 | 18 | 19 | 20 |
| (composition) | | | | | | | | | | |
| Crystallization | | | | | | | | | | |
| conditions | | | | | | | | | | |
| Heating rate to T1 | 5 | 5 | 5 | 5 | 5 | 5 | 5 | 5 | 5 | 5 |
| [° C./min] | | | | | | | | | | |
| Temperature T1 | 900 | 900 | 900 | 900 | 900 | 900 | 900 | 900 | 900 | 900 |
| [° C.] | | | | | | | | | | |
| Holding time t1 [h] | 4.0 | 4.0 | 4.0 | 4.0 | 4.0 | 4.0 | 4.0 | 4.0 | 4.0 | 4.0 |
| Heating rate to T2 | — | — | — | — | — | — | — | — | — | — |
| [° C./min] | | | | | | | | | | |
| Temperature T2 | — | — | — | — | — | — | — | — | — | — |
| [° C.] | | | | | | | | | | |
| Holding time t2 [h] | — | — | — | — | — | — | — | — | — | — |
| Crystal seed | | | | | | | | | | |
| Rutile crystal | 4.5% | 5.0% | 4.0% | 4.0% | 3.5% | 4.0% | 5.0% | 5.0% | 4.0% | 3.5% |
| [mass %] | | | | | | | | | | |
| Properties | | | | | | | | | | |
| Dk @ 10 GHz | 4.9 | 5.1 | 4.8 | 4.8 | 4.5 | 4.7 | 5.1 | 5.0 | 4.9 | 4.8 |
| Df @ 10 GHz | 0.0014 | 0.0017 | 0.0014 | 0.0015 | 0.0012 | 0.0014 | 0.0019 | 0.0013 | 0.0018 | 0.0014 |
| ΔDk @ 10 GHz | −28 | −37 | −22 | −23 | −15 | −24 | −40 | −38 | −23 | −14 |
| Ra [μm] | 0.09 | 0.1 | 0.08 | 0.08 | 0.07 | 0.08 | 0.1 | 0.1 | 0.08 | 0.07 |

TABLE 15

| | Example | Example | Example | Example | Example | Example | Example | Example | Example | Example |
|---|---|---|---|---|---|---|---|---|---|---|
| | 21 | 22 | 23 | 24 | 25 | 26 | 27 | 28 | 29 | 30 |
| Working Example | Working | Working | Working | Working | Working | Working | Working | Working | Working | Working |
| or Comparative | Example | Example | Example | Example | Example | Example | Example | Example | Example | Example |
| Example | | | | | | | | | | |
| Glass number | 21 | 22 | 23 | 24 | 25 | 26 | 27 | 28 | 29 | 30 |
| (composition) | | | | | | | | | | |
| Crystallization | | | | | | | | | | |
| conditions | | | | | | | | | | |
| Heating rate to T1 | 5 | 5 | 5 | 5 | 5 | 5 | 5 | 5 | 5 | 5 |
| [° C./min] | | | | | | | | | | |
| Temperature T1 | 900 | 900 | 900 | 900 | 900 | 900 | 900 | 900 | 900 | 900 |
| [° C.] | | | | | | | | | | |
| Holding time t1 [h] | 4.0 | 4.0 | 4.0 | 4.0 | 4.0 | 4.0 | 4.0 | 4.0 | 4.0 | 4.0 |
| Heating rate to T2 | — | — | — | — | — | — | — | — | — | — |
| [° C./min] | | | | | | | | | | |
| Temperature T2 | — | — | — | — | — | — | — | — | — | — |
| [° C.] | | | | | | | | | | |
| Holding timc t2 [h] | — | — | — | — | — | — | — | — | — | — |
| Crystal seed | | | | | | | | | | |
| Rutile crystal | 3.5% | 4.5% | 4.0% | 5.0% | 3.5% | 3.5% | 3.5% | 5.5% | 3.5% | 5.5% |
| [mass %] | | | | | | | | | | |
| Properties | | | | | | | | | | |
| Dk @ 10 GHz | 4.9 | 5.2 | 6.2 | 5.3 | 4.7 | 6.6 | 5.1 | 5.8 | 4.8 | 4.9 |
| Df @ 10 GHz | 0.0014 | 0.0019 | 0.0060 | 0.0021 | 0.0016 | 0.0070 | 0.0028 | 0.0027 | 0.0017 | 0.0016 |
| ΔDk @ 10 GHz | −14 | −30 | −36 | −39 | −14 | −15 | −14 | −45 | −14 | −45 |
| Ra [μm] | 0.07 | 0.09 | 0.08 | 0.1 | 0.07 | 0.07 | 0.07 | 0.11 | 0.07 | 0.11 |

TABLE 16

| | Example | Example | Example | Example | Example | Example | Example | Example | Example | Example |
|---|---|---|---|---|---|---|---|---|---|---|
| | 31 | 32 | 33 | 34 | 35 | 36 | 37 | 38 | 39 | 40 |
| Working Example | Working | Working | Working | Working | Working | Working | Working | Working | Working | Working |
| or Comparative | Example | Example | Example | Example | Example | Example | Example | Example | Example | Example |
| Example | | | | | | | | | | |
| Glass number | 31 | 32 | 33 | 34 | 35 | 36 | 37 | 38 | 39 | 40 |
| (composition) | | | | | | | | | | |
| Crystallization | | | | | | | | | | |
| conditions | | | | | | | | | | |
| Heating rate to T1 | 5 | 5 | 5 | 5 | 5 | 5 | 5 | 5 | 5 | 5 |
| [° C./min] | | | | | | | | | | |
| Temperature T1 | 900 | 900 | 900 | 900 | 900 | 900 | 900 | 900 | 900 | 900 |
| [° C.] | | | | | | | | | | |
| Holding time t1 [h] | 4.0 | 4.0 | 4.0 | 4.0 | 4.0 | 4.0 | 4.0 | 4.0 | 4.0 | 4.0 |
| Heating rate to T2 | — | — | — | — | — | — | — | — | — | — |
| [° C./min] | | | | | | | | | | |
| Temperature T2 | — | — | — | — | — | — | — | — | — | — |
| [° C.] | | | | | | | | | | |
| Holding timc t2 [h] | — | — | — | — | — | — | — | — | — | — |
| Crystal seed | | | | | | | | | | |
| Rutile crystal | 5.0% | 5.0% | 4.5% | 5.0% | 4.0% | 4.5% | 3.5% | 3.5% | 4.5% | 4.0% |
| [mass %] | | | | | | | | | | |
| Properties | | | | | | | | | | |
| Dk @ 10 GHz | 5.0 | 5.0 | 4.9 | 4.8 | 4.9 | 5.1 | 4.7 | 4.6 | 4.9 | 4.8 |
| Df @ 10 GHz | 0.0016 | 0.0015 | 0.0015 | 0.0014 | 0.0016 | 0.0018 | 0.0017 | 0.0013 | 0.0017 | 0.0017 |
| ΔDk @ 10 GHz | −38 | −37 | −30 | −37 | −22 | −30 | −14 | −14 | −30 | −23 |
| Ra [μm] | 0.1 | 0.1 | 0.09 | 0.1 | 0.08 | 0.09 | 0.07 | 0.07 | 0.09 | 0.08 |

TABLE 17

| | Example | Example | Example | Example | Example | Example | Example | Example | Example | Example |
|---|---|---|---|---|---|---|---|---|---|---|
| | 41 | 42 | 43 | 44 | 45 | 46 | 47 | 48 | 49 | 50 |
| Working Example | Working | Working | Working | Working | Working | Working | Working | Working | Working | Working |
| or Comparative | Example | Example | Example | Example | Example | Example | Example | Example | Example | Example |
| Example | | | | | | | | | | |
| Glass number | 41 | 42 | 43 | 44 | 45 | 46 | 47 | 48 | 49 | 50 |
| (composition) | | | | | | | | | | |
| Crystallization | | | | | | | | | | |
| conditions | | | | | | | | | | |
| Heating rate to T1 | 5 | 5 | 5 | 5 | 5 | 5 | 5 | 5 | 5 | 5 |
| [° C./min] | | | | | | | | | | |
| Temperature T1 | 900 | 900 | 900 | 900 | 900 | 900 | 900 | 900 | 900 | 900 |
| [° C.] | | | | | | | | | | |
| Holding time t1 [h] | 4.0 | 4.0 | 4.0 | 4.0 | 4.0 | 4.0 | 4.0 | 4.0 | 4.0 | 4.0 |
| Heating rate to T2 | — | — | — | — | — | — | — | — | — | — |
| [° C./min] | | | | | | | | | | |
| Temperature T2 | — | — | — | — | — | — | — | — | — | — |
| [° C.] | | | | | | | | | | |
| Holding timc t2 [h] | — | — | — | — | — | — | — | — | — | — |
| Crystal seed | | | | | | | | | | |
| Rutile crystal | 4.0% | 3.5% | 4.0% | 4.0% | 5.5% | 5.0% | 5.0% | 4.5% | 4.0% | 4.0% |
| [mass %] | | | | | | | | | | |
| Properties | | | | | | | | | | |
| Dk @ 10 GHz | 4.8 | 4.7 | 4.8 | 4.8 | 5.1 | 5.1 | 5.0 | 5.5 | 5.5 | 5.5 |
| Df @ 10 GHz | 0.0017 | 0.0016 | 0.0017 | 0.0015 | 0.0018 | 0.0016 | 0.0019 | 0.0028 | 0.0030 | 0.0027 |
| ΔDk @ 10 GHz | −23 | −15 | −23 | −23 | −46 | −37 | −38 | −37 | −29 | −29 |
| Ra [μm] | 0.08 | 0.07 | 0.08 | 0.08 | 0.11 | 0.1 | 0.1 | 0.09 | 0.08 | 0.08 |

TABLE 18

| | Example | Example | Example | Example | Example | Example | Example | Example | Example | Example |
|---|---|---|---|---|---|---|---|---|---|---|
| | 51 | 52 | 53 | 54 | 55 | 56 | 57 | 58 | 59 | 60 |
| Working Example | Working | Working | Working | Working | Working | Working | Working | Working | Working | Working |
| or Comparative | Example | Example | Example | Example | Example | Example | Example | Example | Example | Example |
| Example | | | | | | | | | | |
| Glass number | 51 | 52 | 53 | 54 | 55 | 56 | 57 | 58 | 59 | 60 |
| (composition) | | | | | | | | | | |
| Crystallization | | | | | | | | | | |
| conditions | | | | | | | | | | |
| Heating rate to T1 | 5 | 5 | 5 | 5 | 5 | 5 | 5 | 5 | 5 | 5 |
| [° C./min] | | | | | | | | | | |
| Temperature T1 | 900 | 900 | 900 | 900 | 900 | 900 | 900 | 900 | 900 | 900 |
| [° C.] | | | | | | | | | | |
| Holding time t1 [h] | 4.0 | 4.0 | 4.0 | 4.0 | 1.0 | 4.0 | 4.0 | 4.0 | 4.0 | 4.0 |
| Heating rate to T2 | — | — | — | — | — | — | — | — | — | — |
| [° C./min] | | | | | | | | | | |
| Temperature T2 | — | — | — | — | — | — | — | — | — | — |
| [° C.] | | | | | | | | | | |
| Holding timc t2 [h] | — | — | — | — | — | — | — | — | — | — |
| Crystal seed | | | | | | | | | | |
| Rutile crystal | 4.0% | 4.5% | 3.5% | 5.0% | 5.0% | 4.0% | 4.5% | 4.0% | 5.0% | 3.5% |
| [mass %] | | | | | | | | | | |
| Properties | | | | | | | | | | |
| Dk @ 10 GHz | 5.3 | 5.8 | 5.4 | 5.7 | 5.8 | 5.6 | 5.8 | 5.8 | 5.8 | 5.5 |
| Df @ 10 GHz | 0.0025 | 0.0033 | 0.0027 | 0.0031 | 0.0031 | 0.0032 | 0.0035 | 0.0035 | 0.0030 | 0.0032 |
| ΔDk @ 10 GHz | −27 | −37 | −21 | −44 | −42 | −30 | −38 | −31 | −45 | −22 |
| Ra [μm] | 0.08 | 0.09 | 0.07 | 0.1 | 0.11 | 0.08 | 0.09 | 0.08 | 0.1 | 0.07 |

TABLE 19

| | Example | Example | Example | Example | Example | Example | Example | Example | Example | Example |
|---|---|---|---|---|---|---|---|---|---|---|
| | 61 | 62 | 63 | 64 | 65 | 66 | 67 | 68 | 69 | 70 |
| Working Example | Working | Working | Working | Working | Working | Working | Working | Working | Working | Working |
| or Comparative | Example | Example | Example | Example | Example | Example | Example | Example | Example | Example |
| Example | | | | | | | | | | |
| Glass number | 61 | 62 | 63 | 64 | 65 | 66 | 67 | 68 | 69 | 70 |
| (composition) | | | | | | | | | | |
| Crystallization | | | | | | | | | | |
| conditions | | | | | | | | | | |
| Heating rate to T1 | 5 | 5 | 5 | 5 | 5 | 5 | 5 | 5 | 5 | 5 |
| [° C./min] | | | | | | | | | | |
| Temperature T1 | 900 | 900 | 900 | 900 | 900 | 900 | 900 | 900 | 900 | 900 |
| [° C.] | | | | | | | | | | |
| Holding time t1 [h] | 4.0 | 4.0 | 4.0 | 4.0 | 4.0 | 4.0 | 4.0 | 4.0 | 4.0 | 4.0 |
| Heating rate to T2 | — | — | — | — | — | — | — | — | — | — |
| [° C./min] | | | | | | | | | | |
| Temperature T2 | — | — | — | — | — | — | — | — | — | — |
| [° C.] | | | | | | | | | | |
| Holding time t2 [h] | — | — | — | — | — | — | — | — | — | — |
| Crystal seed | | | | | | | | | | |
| Rutile crystal | 4.0% | 4.5% | 4.5% | 5.0% | 4.0% | 4.0% | 5.0% | 4.5% | 4.5% | 4.0% |
| [mass %] | | | | | | | | | | |
| Properties | | | | | | | | | | |
| Dk @ 10 GHz | 5.7 | 5.7 | 5.7 | 5.8 | 5.7 | 5.6 | 5.5 | 5.5 | 5.5 | 5.3 |
| Df @ 10 GHz | 0.0034 | 0.0035 | 0.0034 | 0.0033 | 0.0034 | 0.0034 | 0.0026 | 0.0029 | 0.0031 | 0.0025 |
| ΔDk @ 10 GHz | −30 | −38 | −38 | −45 | −30 | −30 | −43 | −37 | −38 | −28 |
| Ra [μm] | 0.08 | 0.09 | 0.09 | 0.1 | 0.08 | 0.08 | 0.1 | 0.09 | 0.09 | 0.08 |

TABLE 20

| | Example | Example | Example | Example | Example | Example | Example | Example | Example | Example |
|---|---|---|---|---|---|---|---|---|---|---|
| | 71 | 72 | 73 | 74 | 75 | 76 | 77 | 78 | 79 | 80 |
| Working Example | Working | Working | Working | Working | Working | Working | Working | Working | Working | Working |
| or Comparative | Example | Example | Example | Example | Example | Example | Example | Example | Example | Example |
| Example | | | | | | | | | | |
| Glass number | 71 | 72 | 73 | 74 | 75 | 76 | 77 | 78 | 79 | 80 |
| (composition) | | | | | | | | | | |
| Crystallization | | | | | | | | | | |
| conditions | | | | | | | | | | |
| Heating rate to T1 | 5 | 5 | 5 | 5 | 5 | 5 | 5 | 5 | 5 | 5 |
| [° C./min] | | | | | | | | | | |
| Temperature T1 | 900 | 900 | 900 | 900 | 900 | 900 | 900 | 900 | 900 | 900 |
| [° C.] | | | | | | | | | | |
| Holding time t1 [h] | 3.0 | 3.0 | 4.0 | 3.0 | 3.0 | 3.0 | 3.0 | 3.0 | 3.0 | 3.0 |
| Heating rate to T2 | — | — | — | — | — | — | — | — | — | — |
| [° C./min] | | | | | | | | | | |
| Temperature T2 | — | — | — | — | — | — | — | — | — | — |
| [° C.] | | | | | | | | | | |
| Holding time t2 [h] | — | — | — | — | — | — | — | — | — | — |
| Crystal seed | | | | | | | | | | |
| Rutile crystal | 5.0% | 5.0% | 5.0% | 5.0% | 5.0% | 5.0% | 5.0% | 4.5% | 5.0% | 5.0% |
| [mass %] | | | | | | | | | | |
| Properties | | | | | | | | | | |
| Dk @ 10 GHz | 5.4 | 5.4 | 5.5 | 5.5 | 5.5 | 5.6 | 5.8 | 5.8 | 5.9 | 5.8 |
| Df @ 10 GHz | 0.0026 | 0.0025 | 0.0027 | 0.0027 | 0.0026 | 0.0028 | 0.0030 | 0.0036 | 0.0036 | 0.0030 |
| ΔDk @ 10 GHz | −43 | −43 | −43 | −43 | −43 | −44 | −43 | −38 | −45 | −43 |
| Ra [μm] | 0.1 | 0.1 | 0.1 | 0.1 | 0.1 | 0.1 | 0.1 | 0.09 | 0.1 | 0.1 |

TABLE 21

| | Example | Example | Example | Example | Example | Example | Example | Example | Example | Example |
|---|---|---|---|---|---|---|---|---|---|---|
| | 81 | 82 | 83 | 84 | 85 | 86 | 87 | 88 | 89 | 90 |
| Working | Working | Working | Working | Working | Working | Working | Comparative | Comparative | Comparative | Comparative |
| Example or | Example | Example | Example | Example | Example | Example | Example | Example | Example | Example |
| Comparative | | | | | | | | | | |
| Example | | | | | | | | | | |
| Glass number | 81 | 82 | 83 | 84 | 85 | 86 | 87 | 88 | 89 | 89 |
| (composition) | | | | | | | | | | |
| Crystallization | | | | | | | | | | |
| conditions | | | | | | | | | | |
| Heating rate to | 5 | 5 | 5 | 5 | 5 | 5 | — | — | 5 | 5 |
| T1 [° C./min] | | | | | | | | | | |
| Temperature T1 | 900 | 900 | 900 | 900 | 900 | 900 | — | — | 900 | 1000 |
| [° C.] | | | | | | | | | | |
| Holding time t1 | 3.0 | 3.0 | 3.0 | 3.0 | 3.0 | 3.0 | — | — | 4.0 | 4.0 |
| [h] | | | | | | | | | | |
| Heating rate to | — | — | — | — | — | — | — | — | — | — |
| T2 [° C./min] | | | | | | | | | | |
| Temperature T2 | — | — | — | — | — | — | — | — | — | — |
| [° C.] | | | | | | | | | | |
| Holding time t2 | — | — | — | — | — | — | — | — | — | — |
| [h] | | | | | | | | | | |
| Crystal seed | | | | | | | | | | |
| Rutile crystal | 5.0% | 5.0% | 4.5% | 4.5% | 4.0% | 5.0% | 0.0% | 0.0% | 0.0% | 0.0% |
| [mass %] | | | | | | | | | | |
| Properties | | | | | | | | | | |
| Dk @ 10 GHz | 5.9 | 5.8 | 6.3 | 5.3 | 5.2 | 5.3 | 5.4 | 4.9 | 4.9 | 4.9 |
| Df @ 10 GHz | 0.0034 | 0.0033 | 0.0061 | 0.0023 | 0.0040 | 0.0021 | 0.0065 | 0.0035 | 0.0029 | 0.0029 |
| ΔDk @ 10 GHz | −44 | −45 | −43 | −34 | −26 | −39 | 110 | 77 | 73 | 76 |
| Ra [μm] | 0.1 | 0.1 | 0.09 | 0.09 | 0.08 | 0.1 | 0.009 | 0.01 | 0.008 | 0.009 |

TABLE 22

| | Example 91 | Example 92 |
|---|---|---|
| Working Example or | Comparative | Comparative |
| Comparative Example | Example | Example |
| Glass number (composition) | 89 | 90 |
| Crystallization conditions | | |
| Heating rate to T1 [° C./min] | 5 | 5 |
| Temperature T1 [° C.] | 1050 | 900 |
| Holding time t1 [h] | 4.0 | 4.0 |
| Heating rate to T2 [° C./min] | — | — |
| Temperature T2 [° C.] | — | — |
| Holding time t2 [h] | — | — |
| Crystal seed | | |
| Rutile crystal [mass %] | 0.0% | 8.3% |
| Properties | | |
| Dk @ 10 GHz | 4.9 | 6.2 |
| Df @ 10 GHz | 0.0029 | 0.0029 |
| ΔDk @ 10 GHz | 79 | −154 |
| Ra [μm] | 0.009 | 0.1 |

TABLE 23

| | Example | Example | Example | Example | Example | Example | Example | Example | Example | Example |
|---|---|---|---|---|---|---|---|---|---|---|
| | 93 | 94 | 95 | 96 | 97 | 98 | 99 | 100 | 101 | 102 |
| Working Example | Working | Working | Working | Working | Working | Working | Working | Working | Working | Working |
| or Comparative | Example | Example | Example | Example | Example | Example | Example | Example | Example | Example |
| Example | | | | | | | | | | |
| Glass number | 91 | 92 | 93 | 94 | 95 | 96 | 97 | 98 | 99 | 100 |
| (composition) | | | | | | | | | | |
| Crystallization | | | | | | | | | | |
| conditions | | | | | | | | | | |
| Heating rate to T1 | 5 | 5 | 5 | 5 | 5 | 5 | 5 | 5 | 5 | 5 |
| [° C./min] | | | | | | | | | | |
| Temperature T1 | 840 | 840 | 840 | 840 | 840 | 840 | 840 | 840 | 840 | 840 |
| [° C.] | | | | | | | | | | |
| Holding time t1 [h] | 1.0 | 1.0 | 1.0 | 1.0 | 1.0 | 1.0 | 1.0 | 1.0 | 1.0 | 1.0 |
| Heating rate to T2 | 5 | 5 | 5 | 5 | 5 | 5 | 5 | 5 | 5 | 5 |
| [° C./min] | | | | | | | | | | |
| Temperature T2 | 1200 | 1200 | 1200 | 1225 | 1200 | 1200 | 1200 | 1174 | 1150 | 1200 |
| [° C.] | | | | | | | | | | |
| Holding time t2 [h] | 1 | 1 | 4 | 1 | 1 | 1 | 1 | 0.5 | 1 | 1 |
| Crystal seed | | | | | | | | | | |
| Rutile crystal | 8.0% | 7.0% | 8.0% | 6.0% | 8.0% | 7.5% | 6.5% | 8.0% | 6.0% | 6.5% |
| [mass %] | | | | | | | | | | |
| Cordierite crystal | 55% | 65% | 45% | 55% | 60% | 50% | 55% | 60% | 55% | 50% |
| [mass %] | | | | | | | | | | |
| Indialite crystal | — | — | — | — | — | — | — | — | — | — |
| [mass %] | | | | | | | | | | |
| Properties | | | | | | | | | | |
| Dk @ 10 GHz | 6.0 | 5.7 | 5.8 | 5.9 | 5.8 | 5.9 | 5.9 | 6.0 | 5.8 | 5.7 |
| Df @ 10 GHz | 0.0009 | 0.0008 | 0.0009 | 0.0007 | 0.0009 | 0.0009 | 0.0007 | 0.0008 | 0.0007 | 0.0008 |
| ΔDk @ 10 GHz | 4.6 | 23 | 12 | 31 | 8.6 | 20 | 42 | 7.5 | 35 | 42 |
| Ra [μm] | 0.11 | 0.12 | 0.14 | 0.12 | 0.11 | 0.12 | 0.12 | 0.13 | 0.12 | 0.1 |

TABLE 24

| | Example 103 | Example 104 |
|---|---|---|
| Working Example or | Working | Comparative |
| Comparative Example | Example | Example |
| Glass number (composition) | 101 | 102 |
| Crystallization conditions | | |
| Heating rate to T1 [° C./min] | 5 | 5 |
| Temperature T1 [° C.] | 840 | 1135 |
| Holding time t1 [h] | 1.0 | 12.0 |
| Heating rate to T2 [° C./min] | 5 | — |
| Temperature T2 [° C.] | 1200 | — |
| Holding time t2 [h] | 1 | — |
| Crystal seed | | |
| Rutile crystal [mass %] | 7.0% | 1.5% |
| Cordierite crystal [mass %] | 55% | 60% |
| Indialite crystal [mass %] | — | — |
| Properties | | |
| Dk @ 10 GHz | 5.7 | 5.5 |
| Df @ 10 GHz | 0.0008 | 0.0005 |
| ΔDk @ 10 GHz | 22 | 70 |
| Ra [μm] | 0.12 | 0.13 |

TABLE 25

| | Example 105 | Example 106 | Example 107 | Example 108 | Example 109 |
|---|---|---|---|---|---|
| Working Example or Comparative | Working | Working | Working | Comparative | Comparative |
| Example | Example | Example | Example | Example | Example |
| Glass number (composition) | 103 | 103 | 104 | 103 | 105 |
| Crystallization conditions | | | | | |
| Heating rate to T1 [° C./min] | 5 | 5 | 5 | 5 | 5 |
| Temperature T1 [° C.] | 860 | 1300 | 1070 | 1000 | 1070 |
| Holding time t1 [h] | 6.0 | 0.5 | 4.0 | 0.5 | 4 |
| Heating rate to T2 [° C./min] | 5 | — | — | — | — |
| Temperature T2 [° C.] | 1300 | — | — | — | — |
| Holding time t2 [h] | 4 | — | — | — | — |
| Crystal seed | | | | | |
| Rutile crystal [mass %] | 1.6% | 2.5% | 6.0% | 0.0% | 0.0% |
| Celsian crystal [mass %] | — | — | 66% | — | — |
| Hexa-celsian crystal [mass %] | 50% | 37% | — | 38% | 50% |
| Properties | | | | | |
| Dk @ 10 GHz | 8.0 | 8.2 | 7.7 | 7.3 | 7.3 |
| Df @ 10 GHz | 0.0012 | 0.0011 | 0.0005 | 0.0019 | 0.0022 |
| ΔDk @ 10 GHz | −27 | −39 | −49 | 59 | 89 |
| Ra [μm] | 0.15 | 0.12 | 0.13 | 0.13 | 0.13 |

Tables 1 to 9 show the compositions of the samples as Working Examples and Comparative Examples of the crystallized glass according to Embodiment 2, and Tables 13 to 22 show the heat treatment conditions and the measurement results of the properties. It can be seen that the crystallized glasses in Examples 1 to 86, which are Working Examples, obtained from the glasses 1 to 86, included an appropriate content of TiO₂ and were subjected to an appropriate heat treatment, and thus have a good ΔDk value for all samples, and exhibit stable dielectric properties in a wide temperature range. In addition, it can be seen that, they also have good values for the relative dielectric constant Dk, the dielectric loss tangent Df, and the arithmetic average roughness Ra, and have physical properties suitable as a glass substrate for use in a high frequency device.

Examples 87 and 88 are amorphous glass samples having the compositions of glasses 87 and 88. Since the glasses 87 and 88 include no TiO₂, the rutile crystal does not precipitate, so that no heat treatment is performed. Examples 87 and 88 correspond to Comparative Examples, and Table 9 shows that the samples have a ΔDk value larger than the above preferred range. Therefore, it is thought that the ΔDk can be controlled by precipitating the rutile crystal in the glass.

Examples 89 to 91 are samples in Comparative Examples obtained by subjecting the glass 89 to a heat treatment under three different conditions. In Examples 89 to 91, since the content of TiO₂ was small, the rutile crystal did not precipitate under any heat treatment conditions, and as a result, the ΔDk value of the samples was larger than the above preferred range.

Example 92 is a sample in Comparative Example obtained using the glass 90. In Example 92, since the content of TiO₂ was large, more rutile crystals were precipitated than a predetermined content, and as a result, the ΔDk value of the sample was smaller than the above preferred range.

Tables 10 and 11 show the compositions of samples as Working Examples and Comparative Examples of the crystallized glass according to Embodiment 3, and Tables 23 and 24 show the heat treatment conditions and the measurement results of the properties. It can be seen that the crystallized glasses in Examples 93 to 103, which are Working Examples, obtained from the glasses 91 to 100, included an appropriate content of TiO₂ and were subjected to an appropriate heat treatment, and thus have a good ΔDk value for all samples, and exhibit stable dielectric properties in a wide temperature range. In addition, it can be seen that, they also have good values for the relative dielectric constant Dk, the dielectric loss tangent Df, and the arithmetic average roughness Ra, and have physical properties suitable as a glass substrate for use in a high frequency device.

Example 104 is a sample in Comparative Example obtained using the glass 102. In Example 102, since the content of TiO₂ was small, the rutile crystal did not sufficiently precipitate, and as a result, the ΔDk value of the sample was larger than the above preferred range.

Table 12 shows the compositions of samples as Working Examples and Comparative Examples of the crystallized glass according to Embodiment 4, and Table 25 shows the heat treatment conditions and the measurement results of the properties. It can be seen that the crystallized glasses in Examples 105 to 107, which are Working Examples, obtained from the glasses 103 and 104, included an appropriate content of TiO₂ and were subjected to an appropriate heat treatment, and thus have a good ΔDk value for all samples, and exhibit stable dielectric properties in a wide temperature range. In addition, it can be seen that, they also have good values for the relative dielectric constant Dk, the dielectric loss tangent Df, and the arithmetic average roughness Ra, and have physical properties suitable as a glass substrate for use in a high frequency device.

Example 108 is a sample in Comparative Example obtained using the glass 103. Example 108 is a sample using the glass 103 like Example 105, but since the heat treatment temperature was low and the holding time was short, the rutile crystal did not precipitate. Therefore, the ΔDk value of the sample is larger than the above preferred range.

Example 109 is a sample in Comparative Example obtained using the glass 105. In Example 109, since the glass includes no TiO₂, the rutile crystal did not precipitate, and as a result, the ΔDk value of the sample is larger than the above preferred range.

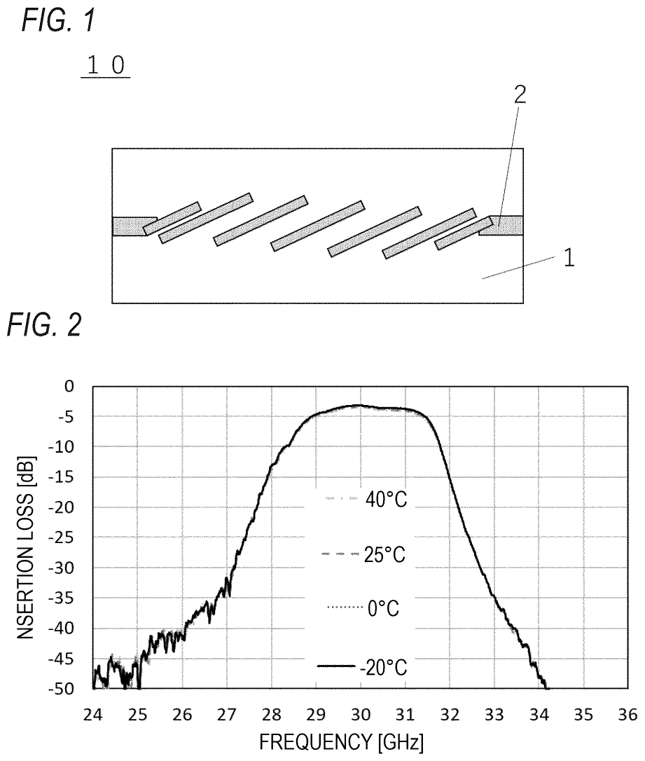

Further, in order to verify the effect of applying the crystallized glass according to the embodiment of the present invention to a high frequency device, a filter device was prepared and the properties thereof were evaluated. FIG. 1 shows a schematic top view of a prepared filter device 10. The filter device 10 includes an electrode 2 formed on a glass substrate 1, and is a device for extracting an electrical signal having a specific frequency. As the electrode 2, Cu was used.

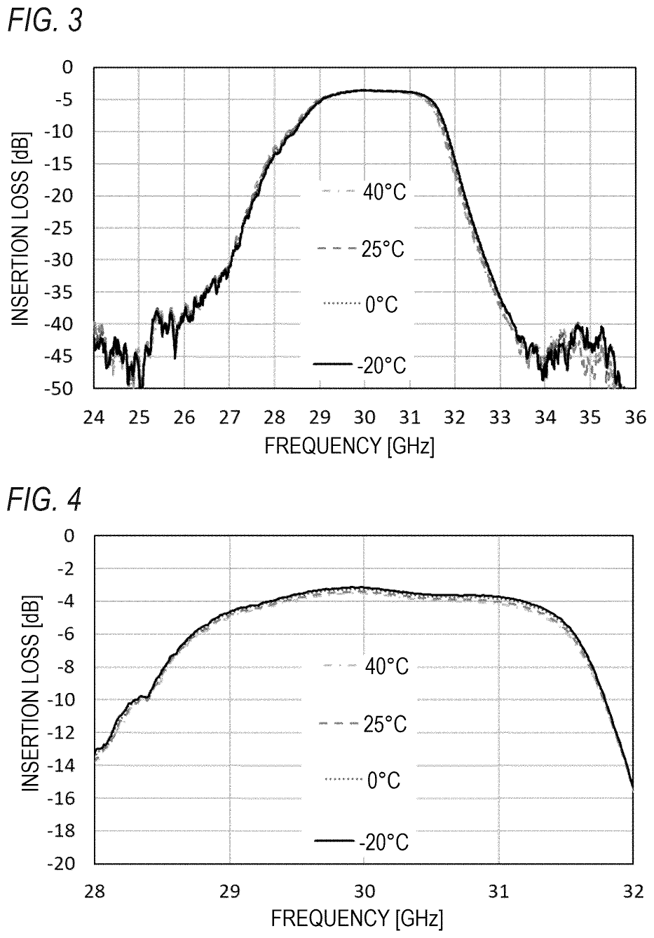

FIG. 2 shows transmission properties of a filter device prepared using the crystallized glass in Example 1, which is a Working Example, measured at temperatures changing from −20° C. to 40° C., with the horizontal axis representing a frequency and the vertical axis representing an insertion loss corresponding to the transmission properties. Further, FIG. 3 shows the measuring results of transmission properties of a filter device prepared using the crystallized glass in Example 87, which is a Comparative Example, measured at temperatures changing from −20° C. to 40° C.

As described above, since the crystallized glass in Example 1, which is an Inventive Example, shows a good ΔDk value, it is thought to have stable dielectric properties in a wide temperature range compared to the crystallized glass in Example 87, which is a Comparative Example. Therefore, it is thought that the transmission properties of the filter device prepared using the crystallized glass in Example 1 are less influenced by a temperature change compared to the transmission properties of the filter device prepared using the crystallized glass in Example 87.

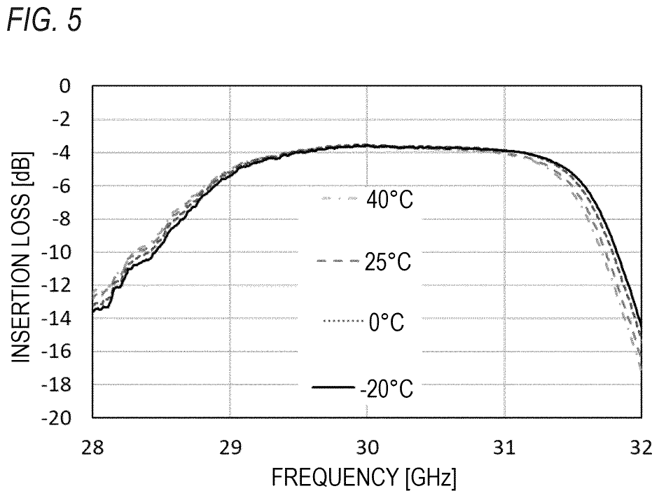

In order to compare the influence of the temperature change on the transmission properties of the filter devices prepared using the respective crystallized glasses in Examples 1 and 87, FIGS. 4 and 5 show enlarged views in a frequency range of 28 GHz to 32 GHz in FIGS. 2 and 3. From FIG. 4, it can be seen that the transmission properties of the filter device prepared using the crystallized glass in Example 1 hardly change even when the temperature changes. On the other hand, from FIG. 5, it can be seen that the transmission properties of the filter device prepared using the crystallized glass in Example 87 change as the temperature changes. Specifically, it can be seen that as the temperature rises, the corresponding frequency gradually shifts to the lower frequency side.

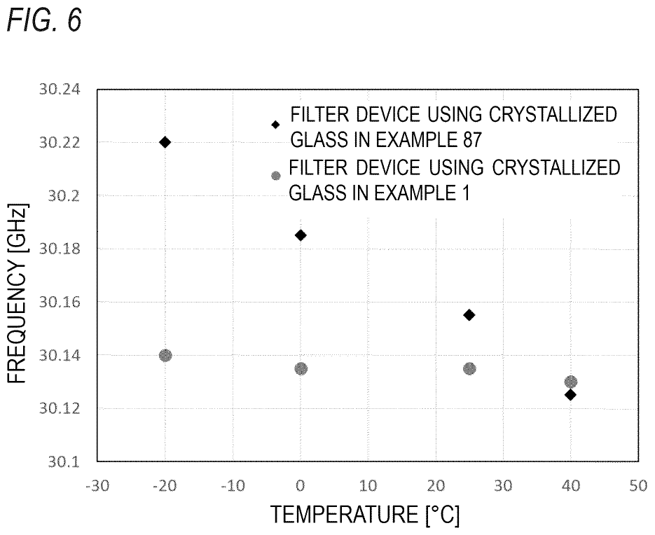

Further, FIG. 6 shows the results of examining a change in center frequency due to temperature in a range where the insertion loss is −5 dB or more, that is, a change in median value of the frequency due to temperature in the range, regarding the transmission properties of the filter devices prepared using the respective crystallized glasses in Examples 1 and 87. From FIG. 6, it can be seen that the center frequency of the filter device prepared using the crystallized glass in Example 1 hardly changes, and the center frequency of the filter device prepared using the crystallized glass in Example 87 decreases as the temperature rises.

When calculating a rate of change in center frequency in the range of −20° C. to 40° C., a center frequency shift of the filter device prepared using the crystallized glass in Example 1 was a rate of change of 55 ppm/K, whereas a center frequency shift of the filter device prepared using the crystallized glass in Example 87 was a rate of change of 524 ppm/K. Therefore, it is thought that by applying the crystallized glass according to the embodiment of the present invention to a high frequency device, it is possible to actually prevent a change in device properties due to temperature.

As described above, the following matters are disclosed in the present description.

1. A crystallized glass, having a value calculated according to the following equation (A) of −50 ppm (/° C.) to 50 ppm (/° C.) when a rate of change ΔDk (/° C.) in a relative dielectric constant at 10 GHz due to a temperature is expressed by the following equation (A), and having a total content of an alkali metal oxide R₂O of 3.0% or less in terms of molar percentage based on oxides,

$$\begin{matrix}[ Math . 3 ] & \\ Δ Dk = \frac{\begin{matrix}( relative dielectric constant at 10 GHz and 60 ° C . ) - \\ ( relative dielectric constant at 10 GHz and \text{-20} ° C . )\end{matrix}}{\begin{matrix}( relative dielectric constant at 10 GHz and 20 ° C . ) \times \\ ( 60 ° C . - ( - 20 ° C . ) )\end{matrix}} & ( A )\end{matrix}$$

2. A glass substrate for a high frequency device, the glass substrate including:
the crystallized glass according to the above 1.

3. A high frequency filter device, including:
the glass substrate according to the above 2.

4. The crystallized glass according to the above 1, including, in terms of molar percentage based on oxides:
50% to 80% of SiO₂;
0.5% to 14% of Al₂O₃;
7% to 35% of B₂O₃;
3.5% to 10% of TiO₂;
0% to 10% of MgO;
0% to 8% of CaO; and
0% to 5% of BaO,
having a total content of an alkaline earth metal oxide RO of 1% to 20%, and
including 0.5 mass % or more of a rutile TiO₂ crystal with respect to the entire crystallized glass.

5. The crystallized glass according to the above 4, including 2.0 mass % or more of the rutile TiO₂ crystal with respect to the entire crystallized glass.

6. The crystallized glass according to the above 4 or 5, having a molar ratio of content represented by Al₂O₃/B₂O₃ of 0.1 to 1.4.

7. The crystallized glass according to any one of the above 4 to 6, having the total content of the alkali metal oxide R₂O of 0.001% to 3.0% in terms of molar percentage based on oxides.

8. The crystallized glass according to the above 1, including, in terms of molar percentage based on oxides:
51% to 70% of SiO₂;
12% to 30% of Al₂O₃;
0.5% to 10% of P₂O₅;
15% to 23% of MgO;
0% to 1.5% of CaO; and
6% to 15% of TiO₂, in which
the crystallized glass includes 4.5 mass % or more of a rutile TiO₂ crystal with respect to the entire crystallized glass, and
includes at least one crystal of an indialite crystal and a cordierite crystal.

9. The crystallized glass according to the above 8, in which contents of CaO, SrO, and BaO in terms of molar percentage based on oxides satisfy a relationship CaO>SrO>BaO.

10. The crystallized glass according to the above 1, including, in terms of molar percentage based on oxides:
45% to 65% of SiO₂;
7.5% to 30% of Al₂O₃;
0.5% to 15% of P₂O₅;
13% to 30% of a total content of one or more selected from SrO and BaO;
2.5% to 10% of TiO₂; and
0% to 10% of ZrO₂, in which
the crystallized glass includes 2.0 mass % or more of a rutile TiO₂ crystal with respect to the entire crystallized glass, and
includes at least one crystal of a celsian crystal and a hexa-celsian crystal.

11. The crystallized glass according to any one of the above 1 and 4 to 10, having a relative dielectric constant Dk at 10 GHz and 20° C. of 8.5 or less.

12. The crystallized glass according to any one of the above 1 and 4 to 11, having a dielectric loss tangent Df at 10 GHz and 20° C. of 0.01 or less.

13. The crystallized glass according to any one of the above 1 and 4 to 12, in which the crystallized glass includes two main surfaces facing each other, and at least one of the main surfaces has an arithmetic average roughness Ra of 2 μm or less.

14. The crystallized glass according to any one of the above 1 and 4 to 13, having a thickness of 0.01 mm to 2 mm.

15. The crystallized glass according to any one of the above 1 and 4 to 14, having an area of a largest surface of 100 cm² to 100,000 cm².

16. A glass substrate for a high frequency device, the glass substrate including: the crystallized glass according to any one of the above 4 to 15.

17. A high frequency filter device, including:
the glass substrate according to the above 16.

18. A liquid crystal antenna including:
the crystallized glass according to any one of the above 1 and 4 to 15.

19. An amorphous glass including, in terms of molar percentage based on oxides:
50% to 80% of SiO₂;
0.5% to 14% of Al₂O₃;
7% to 35% of B₂O₃;
3.5% to 10% of TiO₂;
0% to 10% of MgO;
0% to 8% of CaO; and
0% to 5% of BaO,
having a total content of an alkali metal oxide R₂O of 3.0% or less, and
having a total content of an alkaline earth metal oxide RO of 1% to 20%,
in which Nb, Bi, and Cu are not contained in the amorphous glass.

20. A crystallized glass production method including:
holding the amorphous glass according to the above 19 at 800° C. or higher for 0.5 hours or longer.

Although the present invention has been described in detail with reference to specific embodiments, it is apparent to those skilled in the art that various changes and modifications can be made without departing from the spirit and scope of the present invention. The present application is based on a Japanese Patent Application (No. 2022-004643) filed on Jan. 14, 2022, the contents of which are incorporated herein by reference.

### INDUSTRIAL APPLICABILITY

The crystallized glass according to the present invention exhibits stable dielectric properties in a wide temperature range as a glass substrate for use in a high frequency device. Such a crystallized glass is very useful as a member of general high frequency electronic devices such as a high frequency substrate that copes with a high frequency signal exceeding 10 GHz, particularly a high frequency signal exceeding 30 GHz, and further a high frequency signal of 35 GHz or more, of liquid crystal antennas for use in an environment where a temperature change is large, of devices involving drilling by laser, or the like.

1. A crystallized glass, having a value calculated according to the following equation (A) of −50 ppm (/° C.) to 50 ppm (/° C.) when a rate of change ΔDk (/° C.) in a relative dielectric constant at 10 GHz due to a temperature is expressed by the following equation (A), and having a total content of an alkali metal oxide R₂O of 3.0% or less in terms of molar percentage based on oxides,
$$\begin{matrix}[ Math . 1 ] & \\ Δ Dk = \frac{\begin{matrix}( relative dielectric constant at 10 GHz and 60 ° C . ) - \\ ( relative dielectric constant at 10 GHz and \text{-20} ° C . )\end{matrix}}{\begin{matrix}( relative dielectric constant at 10 GHz and 20 ° C . ) \times \\ ( 60 ° C . - ( - 20 ° C . ) )\end{matrix}} & ( A )\end{matrix}$$

2. A glass substrate for a high frequency device, the glass substrate comprising:
the crystallized glass according to claim 1.

3. A high frequency filter device, comprising:
the glass substrate according to claim 2.

4. The crystallized glass according to claim 1, comprising, in terms of molar percentage based on oxides:
50% to 80% of SiO₂;
0.5% to 14% of Al₂O₃;
7% to 35% of B₂O₃;
3.5% to 10% of TiO₂;
0% to 10% of MgO;
0% to 8% of CaO; and
0% to 5% of BaO,
having a total content of an alkaline earth metal oxide RO of 1% to 20%, and
comprising 0.5 mass % or more of a rutile TiO₂ crystal with respect to the entire crystallized glass.

5. The crystallized glass according to claim 4, comprising 2.0 mass % or more of the rutile TiO₂ crystal with respect to the entire crystallized glass.

6. The crystallized glass according to claim 4, having a molar ratio of content represented by Al₂O₃/B₂O₃ of 0.1 to 1.4.

7. The crystallized glass according to claim 4, having the total content of the alkali metal oxide R₂O of 0.001% to 3.0% in terms of molar percentage based on oxides.

8. The crystallized glass according to claim 1, comprising, in terms of molar percentage based on oxides:
51% to 70% of SiO₂;
12% to 30% of Al₂O₃;
0.5% to 10% of P₂O₅;
15% to 23% of MgO;
0% to 1.5% of CaO; and
6% to 15% of TiO₂, wherein
the crystallized glass comprises 4.5 mass % or more of a rutile TiO₂ crystal with respect to the entire crystallized glass, and
comprises at least one crystal of an indialite crystal and a cordierite crystal.

9. The crystallized glass according to claim 8, wherein contents of CaO, SrO, and BaO in terms of molar percentage based on oxides satisfy a relationship CaO>SrO>BaO.

10. The crystallized glass according to claim 1, comprising, in terms of molar percentage based on oxides:
45% to 65% of SiO₂;
7.5% to 30% of Al₂O₃;
0.5% to 15% of P₂O₅;
13% to 30% of a total content of one or more selected from SrO and BaO;
2.5% to 10% of TiO₂; and
0% to 10% of ZrO₂, wherein
the crystallized glass comprises 2.0 mass % or more of a rutile TiO₂ crystal with respect to the entire crystallized glass, and
comprises at least one crystal of a celsian crystal and a hexa-celsian crystal.

11. The crystallized glass according to claim 1, having a relative dielectric constant Dk at 10 GHz and 20° C. of 8.5 or less.

12. The crystallized glass according to claim 1, having a dielectric loss tangent Df at 10 GHz and 20° C. of 0.01 or less.

13. The crystallized glass according to claim 1, wherein the crystallized glass comprises two main surfaces facing each other, and at least one of the main surfaces has an arithmetic average roughness Ra of 2 μm or less.

14. The crystallized glass according to claim 1, having a thickness of 0.01 mm to 2 mm.

15. The crystallized glass according to claim 1, having an area of a largest surface of 100 cm² to 100,000 cm².

16. A glass substrate for a high frequency device, the glass substrate comprising:
the crystallized glass according to claim 1.

17. A high frequency filter device, comprising:
the glass substrate according to claim 16.

18. A liquid crystal antenna comprising:
the crystallized glass according to claim 1.

19. An amorphous glass comprising, in terms of molar percentage based on oxides:
50% to 80% of SiO₂;
0.5% to 14% of Al₂O₃;
7% to 35% of B₂O₃;
3.5% to 10% of TiO₂;
0% to 10% of MgO;
0% to 8% of CaO; and
0% to 5% of BaO,
having a total content of an alkali metal oxide R₂O of 3.0% or less, and
having a total content of an alkaline earth metal oxide RO of 1% to 20%,
wherein Nb, Bi, and Cu are not contained in the amorphous glass.

20. A crystallized glass production method comprising:
holding the amorphous glass according to claim 19 at 800° C. or higher for 0.5 hours or longer.
